(19) United States
(12) Patent Application Publication
(10) Pub. No.: US 2010/0253775 A1
(43) Pub. Date: Oct. 7, 2010

(54) NAVIGATION DEVICE

(76) Inventors: Yoshihisa Yamaguchi, Tokyo (JP); Takashi Nakagawa, Tokyo (JP); Toyoaki Kitano, Tokyo (JP); Hideto Miyazaki, Tokyo (JP); Tsutomu Matsubara, Tokyo (JP)

Correspondence Address: BIRCH STEWART KOLASCH & BIRCH, PO BOX 747, FALLS CHURCH, VA, 22040-0747, US

(21) Appl. No.: 12/742,416

(22) PCT Filed: Nov. 18, 2008
(86) PCT No.: PCT/JP2008/003362

§ 371 Date: May 11, 2010

(30) Foreign Application Priority Data
Jan. 31, 2008 (JP) 2008-021208

(51) Int. Cl. H04N 7/18; G01C 21/36; G08G 1/0969

(52) U.S. Cl. 348/135; 701/211; 348/E07.085

(57) ABSTRACT

A navigation device includes a last shot determining unit 6 for, when a distance from the current position to a guidance object is equal to or shorter than a fixed distance and a distance from a current position calculated on the basis of map data to the guidance object is equal to or shorter than the fixed distance, determining to switch to a last shot mode, a video image storage unit 11 for storing, as a last shot video image, a video image acquired by a video image acquiring unit 10 at the time when it is determined to switch to the last shot mode, a video image composite processing unit 24 for superimposing a content existing in the stored last shot video image on the last shot video image to generate a composite video image, and a display unit 13 for displaying the composite video image.

### FIELD OF THE INVENTION

The present invention relates to a navigation device that guides a user to his or her destination. More particularly, it relates to a technology of guiding a user by using an actually captured video image acquired by capturing a video image by using a camera.

### BACKGROUND OF THE INVENTION

Conventionally, a technology for use in a car navigation device, of providing a route guidance by superimposing guidance information on a video image, which is acquired by capturing a frontal area of a vehicle in real time with a vehicle-mounted camera while the vehicle travels, by using CG (Computer Graphics) to display the guidance information is known (for example, refer to patent reference 1).

Furthermore, patent reference 2 discloses, as a similar technology, a car navigation system that displays a navigation information element in such a way to make it easy for users to grasp the navigation information element sensuously. This car navigation system captures a scene in the traveling direction of a vehicle with an imaging camera attached to the nose or the like of the vehicle, enables a user to select, as a background image to be displayed behind the navigation information element, either a map image or an actually captured video image by using a selector, and superimposes the navigation information element on this background image by using an image compositing unit to display the navigation information element on a display unit. This patent reference 2 discloses a technology associated with route guidance for an intersection using an actually captured video image, of displaying a route guidance arrow only along a road along which a user is to be guided. Furthermore, as a method of superimposing the route guidance arrow on an image without analyzing the image, a technology of generating the arrow from a CG image of the same line of sight angle and the same display scale as those of an actually captured video image, and superimposing the arrow on the actually captured video image is disclosed.
[Patent reference 1] JP,2915508,B
[Patent reference 2] JP,11-108684,A

### DISCLOSURE OF THE INVENTION

According to the technologies disclosed by above-mentioned patent references 1 and 2, a video image acquired in real time is displayed on the display unit and a route guidance for an intersection is then provided, though the driver concentrates on driving the vehicle in many cases until he or she completes making a right or left turn after the vehicle has entered the intersection, and therefore the video image acquired in real time is hardly utilized even if the video image is displayed on the display unit. A further problem is that in a situation in which the vehicle is entering an intersection, a video image from which the driver cannot get a full view of the intersection clearly is displayed in many cases because of the field angle of the camera.

The present invention is made in order to solve the above-mentioned problems, and it is therefore an object of the present invention to provide a navigation device that can present appropriate information to a user when, for example, a vehicle is traveling in the neighborhood of a guidance object such as an intersection.

In order to solve the above-mentioned problems, a navigation device in accordance with the present invention includes: a map database holding map data; a position and heading measuring unit for measuring a current position; a video image acquiring unit for acquiring a video image; a last shot determining unit for, when a distance from the current position acquired by the position and heading measurement unit to a guidance object is equal to or shorter than a fixed distance and a distance from a current position calculated on a basis of map data acquired from the map database to the guidance object is equal to or shorter than the fixed distance, determining to switch to a last shot mode in which a video image acquired by the video image acquiring unit at that time is fixedly and continuously outputted; a video image storage unit for storing, as a last shot video image, a video image acquired by the video image acquiring unit at a time when the last shot determining unit determines to switch to the last shot mode; a video image composite processing unit for reading the last shot video image stored in the video image storage unit, and for superimposing a content including a graphic, a character string or an image for explaining the guidance object existing in the last shot video image on the read last shot video image to generate a composite video image; and a display unit for displaying the composite video image generated by the video image composite processing unit.

The navigation device in accordance with the present invention is configured in such a way as to, when the distance from a guidance object becomes equal to or shorter than the fixed distance, switch to the last shot mode in which the navigation device fixedly and continuously outputs a video image acquired at that time. Therefore, because the navigation device in accordance with the present invention can prevent a video image unsuitable for guidance, e.g. a video image including a guidance object partially extending off screen when the navigation device approaches the guidance object too much from being displayed, the navigation device makes the display of the video image legible, and can present proper information to a user in the neighborhood of the guidance object such as an intersection.

### BRIEF DESCRIPTION OF THE FIGURES

FIG. 1 is a block diagram showing the configuration of a navigation device in accordance with Embodiment 1 of the present invention;

FIG. 2 is a flow chart showing a content composite video image generating process carried out by the navigation device in accordance with Embodiment 1 of the present invention;

FIG. 3 is a flow chart showing the details of a content generating process carried out in the content composite video image generating process by the navigation device in accordance with Embodiment 1 of the present invention;

FIG. 4 is a view showing an example of content types for use with the navigation device in accordance with Embodiment 1 of the present invention;

FIG. 5 is a flow chart showing a last shot determining process carried out by the navigation device in accordance with Embodiment 1 of the present invention;

FIG. 6 is a flow chart showing a video image storage process carried out by the navigation device in accordance with Embodiment 1 of the present invention;

FIG. 7 is a flow chart showing a video image acquiring process carried out in the content composite video image generating process by the navigation device in accordance with Embodiment 1 of the present invention;

FIG. 8 is a flow chart showing a vehicle position and heading storage process carried out by the navigation device in accordance with Embodiment 1 of the present invention;

FIG. 9 is a flow chart showing a position and heading acquiring process carried out in the content composite video image generating process by the navigation device in accordance with Embodiment 1 of the present invention;

FIG. 10 is a view showing an example of an on-the-spot guide view displayed on the screen of a display unit in the navigation device in accordance with Embodiment 1 of the present invention;

FIG. 11 is a flow chart showing a last shot determining process carried out by a navigation device in accordance with Embodiment 2 of the present invention;

FIG. 12 is a flow chart showing a last shot determining process carried out by a navigation device in accordance with Embodiment 3 of the present invention;

FIG. 13 is a flow chart showing a last shot determining process carried out by a navigation device in accordance with Embodiment 4 of the present invention;

FIG. 14 is a flow chart showing a last shot determining process carried out by a navigation device in accordance with Embodiment 5 of the present invention;

FIG. 15 is a block diagram showing the configuration of a navigation device in accordance with Embodiment 6 of the present invention;

FIG. 16 is a flow chart showing a last shot determining process carried out by the navigation device in accordance with Embodiment 6 of the present invention;

FIG. 17 is a flow chart showing a guidance object detecting process carried out by the navigation device in accordance with Embodiment 6 of the present invention;

FIG. 18 is a block diagram showing the configuration of a navigation device in accordance with Embodiment 7 of the present invention;

FIG. 19 is a flow chart showing a video image storage process carried out by the navigation device in accordance with Embodiment 7 of the present invention; and

FIG. 20 is a flow chart showing a vehicle position and heading storage process carried out by the navigation device in accordance with Embodiment 7 of the present invention.

### PREFERRED EMBODIMENTS OF THE INVENTION

Hereafter, preferred embodiments of the present invention will be described with reference to the accompanying drawings.

### Embodiment 1

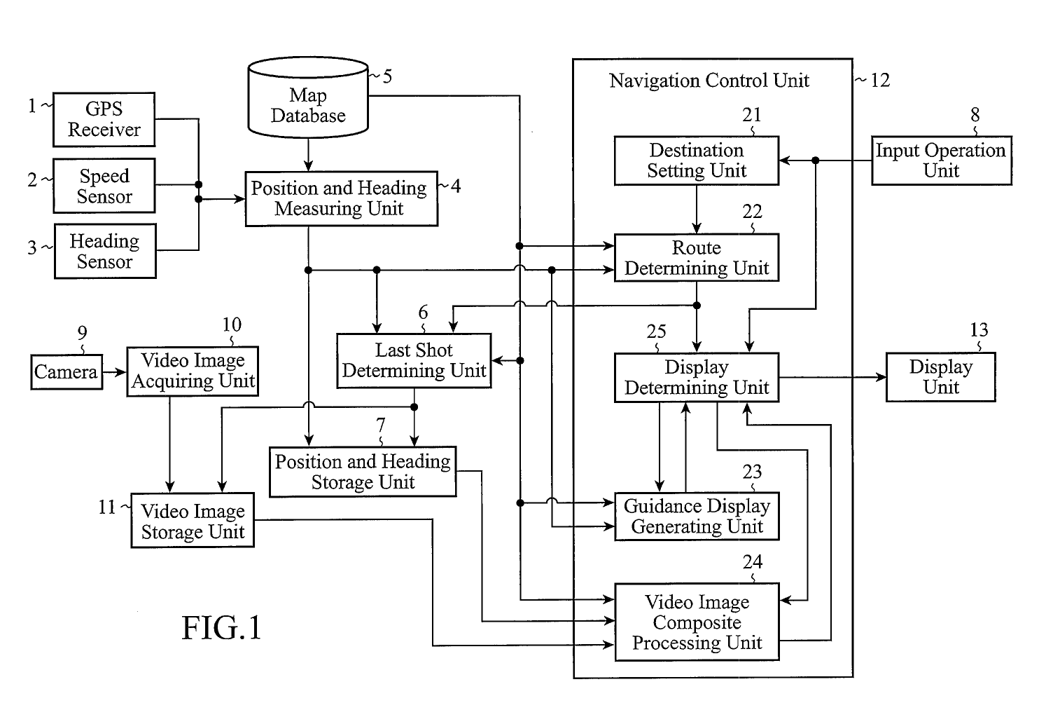

FIG. 1 is a block diagram showing the configuration of a navigation device in accordance with Embodiment 1 of the present invention. Hereafter, as an example of the navigation device, a car navigation device mounted in a vehicle will be explained. The navigation device is provided with a GPS (Global Positioning System) receiver 1, a speed sensor 2, a heading sensor 3, a position and heading measuring unit 4, a map database 5, a last shot determining unit 6, a position and heading storage unit 7, an input operation unit 8, a camera 9, a video image acquiring unit 10, a video image storage unit 11, a navigation control unit 12, and a display unit 13.

The GPS receiver 1 measures the position of the vehicle by receiving radio waves from a plurality of satellites. The vehicle position measured by this GPS receiver 1 is informed, as a vehicle position signal, to the position and heading measuring unit 4. The speed sensor 2 measures the speed of the vehicle successively. This speed sensor 2 is typically comprised of a sensor for measuring the number of revolutions of a tire. The speed of the vehicle measured by the speed sensor 2 is informed, as a vehicle speed signal, to the position and heading measuring unit 4. The heading sensor 3 measures the traveling direction of the vehicle successively. The traveling direction (referred to as the “heading” from here on) of the vehicle measured with this heading sensor 3 is informed, as a heading signal, to the position and heading measuring unit 4.

The position and heading measuring unit 4 measures the current position and heading of the vehicle from the vehicle position signal sent thereto from the GPS receiver 1. When the sky above the vehicle is obstructed by something like a tunnel or a surrounding building, the number of satellites from which the GPS receiver can receive radio waves becomes zero or decreases and their reception states get worse, and hence the position and heading measuring unit becomes impossible to measure the current position and heading of the vehicle from only the vehicle position signal from the GPS receiver 1 or their degrees of accuracy get worse even if the position and heading measuring unit can measure the current position and heading of the vehicle. To solve this problem, the position and heading measuring unit performs a process of measuring the vehicle position by using dead reckoning using the vehicle speed signal from the speed sensor 2 and the heading signal from the heading sensor 3 to correct the measurement result acquired by the GPS receiver 1.

As mentioned above, the current position and heading of the vehicle which are measured by the position and heading measuring unit 4 include various errors like an error of the vehicle speed resulting from deterioration of the measurement accuracy which is caused by deterioration of the reception state of the GPS receiver 1, a change in the diameter of the tire due to wear of the tire, and a temperature change, and an error resulting from the accuracy of the sensor itself. Therefore, the position and heading measuring unit 4 corrects the current position and heading of the vehicle acquired through the measurement and including the errors by carrying out map matching using road data acquired from map data read from the map database 5. These corrected current position and heading of the vehicle are informed, as vehicle position and heading data, to the last shot determining unit 6, the position and heading storage unit 7, and the navigation control unit 12.

The map database 5 holds map data including data about facilities in the neighborhood of each road (street), in addition to road data such as the position of each road, the type of each road (highway (freeway), toll road, local street, or minor street), restrictions regarding each road (a speed limit or one-way traffic), and lane information in the neighborhood of each intersection. Each road is expressed by a plurality of nodes and links each connecting between nodes in a straight line, and the position of each road is expressed by recording the latitude and longitude of each of these nodes. For example, a node to which three or more links are connected shows that a plurality of roads cross at the position of the node. Map data currently held by this map database 5 can be read by the position and heading measuring unit 4 as mentioned above, and can also be read by the last shot determining unit 6 and the navigation control unit 12.

The last shot determining unit 6 uses guidance route data (which will be mentioned below in detail) sent thereto from the navigation control unit 12, the vehicle position and heading data sent from the position and heading measuring unit 4, and map data acquired from the map database 5 to determine whether or not to switch to a last shot mode. The last shot mode means an operation mode in which the car navigation device fixedly and continuously outputs, as a last shot video image, a video image which the car navigation device acquires at the time when the distance from the current position to a guidance object becomes equal to or shorter than a fixed distance, so as to present guidance to a user. The last shot video image does not need to be strictly limited to the video image which the car navigation device acquires at the time when the distance from the current position to the guidance object becomes equal to or shorter than the fixed distance. For example, as the last shot video image, a video image which is acquired before or after that time, and which includes the guidance object in a central area thereof or which includes a clear view in a frontal area of the vehicle can be used.

When determining to switch to the last shot mode, the last shot determining unit 6 turns on the last shot mode, or otherwise the last shot determining unit turns off the last shot mode, and sends a last shot mode signal showing the turning on or off of the last shot mode to the position and heading storage unit 7 and the video image storage unit 11. The process performed by this last shot determining unit 6 will be further explained below in detail.

When the last shot mode signal received from the last shot determining unit 6 shows the turning on of the last shot mode, the position and heading storage unit 7 stores the vehicle position and heading data sent thereto from the position and heading measuring unit 4 at that time therein. Furthermore, when the last shot mode signal received from the last shot determining unit 6 shows the turning off of the last shot mode, the position and heading storage unit 7 discards the vehicle position and heading data stored therein. In addition, if the vehicle position and heading data are already stored when receiving a position and heading acquisition request from the navigation control unit 12, the position and heading storage unit 7 sends the vehicle position and heading data stored therein to the navigation control unit 12, whereas unless the vehicle position and heading data are already stored when receiving the position and heading acquisition request, the position and heading storage unit 7 acquires the vehicle position and heading data from the position and heading measuring unit 4 and sends the vehicle position and heading data to the navigation control unit 12. The process performed by this position and heading storage unit 7 will be further explained below in detail.

The input operation unit 8 is comprised of at least one of a remote controller, a touch panel, and a voice recognition unit, and is used in order for the driver or a fellow passenger who is a user to input his or her destination or select one of pieces of information provided by the navigation device by performing an input operation. Data generated through the user's input operation on this input operation unit 8 is sent, as operation data, to the navigation control unit 12.

The camera 9 is comprised of at least one of a camera for capturing a video image of a frontal area of the vehicle, and a camera capable of capturing a video image of a wide area including all the surroundings of the vehicle at a time, and captures the neighborhood of the vehicle including the traveling direction of the vehicle. An image signal acquired by capturing a video image with this camera 9 is sent to the video image acquiring unit 10.

The video image acquiring unit 10 converts the image signal sent thereto from the camera 9 into a digital signal which can be processed by a computer. The digital signal acquired through the conversion by this video image acquiring unit 10 is sent to the video image storage unit 11 as video data.

When the last shot mode signal received from the last shot determining unit 6 shows the turning on of the last shot mode, the video image storage unit 11 acquires the video data sent thereto from the video image acquiring unit 10 at that time to store the video data therein. In contrast, when the last shot mode signal received from the last shot determining unit 6 shows the turning off of the last shot mode, the video image storage unit 11 discards the video data stored therein. Furthermore, if the video data is stored when receiving a video image acquisition request from the navigation control unit 12, the video image storage unit 11 sends the video data stored therein to the navigation control unit 12, whereas unless the video data is stored when receiving the video image acquisition request, the video image storage unit 11 acquires the video data from the video image acquiring unit 10 and sends the video data to the navigation control unit 12. The process carried out by this video image storage unit 11 will be further explained below in detail.

The navigation control unit 12 carries out a data process of providing both a function of displaying a map of an area in the neighborhood of the vehicle which the navigation device has, the function including calculation of a guidance route to the destination inputted from the input operation unit 8, generation of guidance information according to both the guidance route and the current position and heading of the vehicle, and generation of a guide map which is obtained by compositing the map of the area in the neighborhood of the vehicle position and a vehicle mark showing the vehicle position, a function for guiding the vehicle to the destination, and so on, and also carries out a data process including a search for information such as traffic information relevant to the vehicle position, the destination, or the guidance route, information about sightseeing areas, restaurants, or stores (shops), and a search for facilities which match conditions inputted from the input operation unit 8.

Furthermore, the navigation control unit 12 generates display data used for either displaying one of the map generated on the basis of the map data read from the map database 5, the video image shown by the video data acquired from the video image acquiring unit 10, and the composite image generated by the video image composite processing unit 24 (the details of the video image composite processing unit will be mentioned below) disposed within the navigation control unit independently, or displaying a combination of them. The details of this navigation control unit 12 will be mentioned below. The display data generated through the various processes carried out y the navigation control unit 12 are sent to the display unit 13.

The display unit 13 is comprised of, for example, an LCD (Liquid Crystal Display), and displays a map, an actually captured video image, and/or another image on the screen thereof according to the display data sent thereto from the navigation control unit 12.

Next, the details of the navigation control unit 12 will be explained. The navigation control unit 12 is provided with a destination setting unit 21, a route determining unit 22, a guidance display generating unit 23, a video image composite processing unit 24, and a display determining unit 25. In FIG. 1, a part of connections between the plurality of above-mentioned components is omitted in order to avoid the complicatedness of the drawing, each omitted portion will be explained hereafter whenever it appears.

The destination setting unit 21 sets up a destination according to operation data sent thereto from the input operation unit 8. The destination set up by this destination setting unit 21 is informed to the route calculating unit 22 as destination data. The route determining unit 22 determines a guidance route to the destination by using the destination data sent thereto from the destination setting unit 21, the vehicle position and heading data sent thereto from the position and heading measuring unit 4, and the map data read from the map database 5. The guidance route determined by this route determining unit 22 is informed to the last shot determining unit 6 and the display determining unit 25 as guidance route data.

The guidance display generating unit 23 generates a guide view based on a map (referred to as a “map-based guide view” from here on) , which is used in a conventional car navigation device, according to a command from the display determining unit 25. The map-based guide view generated by this guidance display generating unit 23 include various guide maps which do not use any actually captured video image, such as a planar map, an enlarged view of an intersection, and a schematic view of highways. Furthermore, the map-based guide view is not limited to a planar map, and can be a guide map using three-dimensional CG or a guide map which is a bird's eye view of a planar map. Because a technology of generating such a map-based guide view is well known, the detailed explanation of the technology will be omitted hereafter. The map-based guide view generated by this guidance display generating unit 23 is sent to the display determining unit 25 as map-based guide view data.

The video image composite processing unit 24 generates a guide map (referred to as an “on-the-spot guide map” from here on) which uses an actually captured video image according to a command from the display determining unit 25. For example, the video image composite processing unit 24 acquires information about all objects to be provided as guidance (collectively referred to as “guidance objects” from here on) by the navigation device, such as a route along which the vehicle is to be guided, and a road network, a landmark, or an intersection in the neighborhood of the vehicle from the map data read from the map database 5, and generates a content composite video image in which a graphic, a character string, or a image (referred to as a “content” from here on) used for explaining the shape, a description or the like of a guidance object is superimposed in the vicinity of an actually captured video image of the guidance object which is shown by the video data sent from the video image acquiring unit 10. The process carried out by this video image composite processing unit 24 will be further explained below in detail. The content composite video image generated by the video image composite processing unit 24 is sent to the display determining unit 25 as on-the-spot guide view data.

As mentioned above, the display determining unit 25 commands the guidance display generating unit 23 to generate a map-based guide view and also commands the video image composite processing unit 24 to generate an on-the-spot guide view. The display determining unit 25 determines information to be displayed on the screen of the display unit 13 on the basis of the vehicle position and heading data sent thereto from the position and heading measuring unit 4, the map data about the map of the area in the neighborhood of the vehicle read from the map database 5, and the operation data sent thereto from the input operation unit 8. Data corresponding to the information to be displayed determined by this display determining unit 25, i.e., the map-based guide view data sent thereto from the guidance display generating unit 23 and the on-the-spot guide view data sent thereto from the video image composite processing unit 24 are sent to the display unit 13 as display data.

As a result, for example, when the vehicle is approaching an intersection, the display unit 13 displays an enlarged view of the intersection. When a menu button of the input operation unit 8 is pushed, the display unit 13 displays a menu. When the display unit is set to an on-the-spot display mode by the input operation unit 8, the display unit displays an on-the-spot guide view using an actually captured video image. The car navigation device can switch to the on-the-spot guide view using an actually captured video image not only when the display unit is set to the on-the-spot display mode, but also when the distance between the position of the vehicle and an intersection at which the vehicle should make a turn becomes equal to or shorter than a constant value.

Furthermore, the guide view displayed on the screen of the display unit 13 can be formed in such a way that the map-based guide view (e.g. a planar map) generated by the guidance display generating unit 23 and the on-the-spot guide view (e.g. an enlarged view of an intersection using an actually captured video image) generated by the video image composite processing unit 24 are simultaneously displayed in a single screen, for example, in such a way that the map-based guide view is placed on a left-hand side of the screen and the on-the-spot guide view is placed on a right-hand side of the screen.

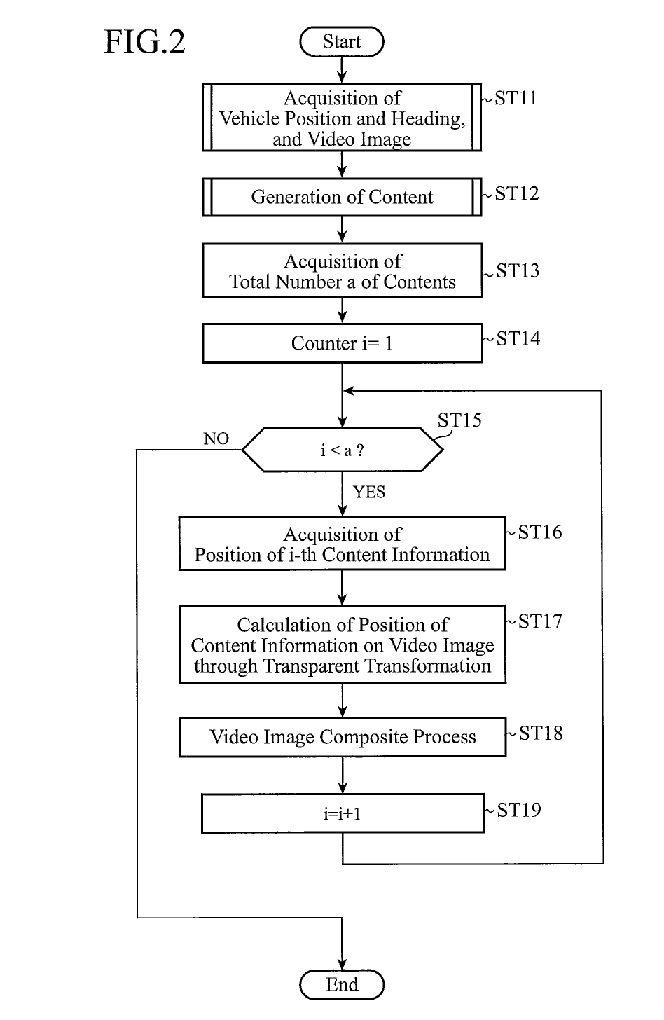

Next, the operation of the navigation device in accordance with Embodiment 1 of the present invention which is configured as mentioned above will be explained. According to travel of the vehicle, this navigation device generates a surrounding map about an area surrounding the vehicle, as the map-based guide view, which is a combination of the surrounding map and a graphic (a vehicle mark) showing the vehicle position, and a content composite video image as the on-the-spot guide view, and displays these surrounding map and content composite video image on the display unit 13. Because a process of generating a surrounding map about an area surrounding the vehicle as the map-based guide view is well known, the explanation of the process will be omitted hereafter. Hereafter, a process of generating a content composite video image as the on-the-spot guide view will be explained with reference to a flow chart shown in FIG. 2. This content composite video image generating process is performed mainly by the video image composite processing unit 24.

In the content composite video image generating process, the position and heading of the vehicle and a video image are acquired first (step ST11). More specifically, the video image composite processing unit 24 sends a position and heading acquisition request to the position and heading storage unit 7 to acquire the vehicle position and heading data sent thereto from the position and heading storage unit 7 in response to this position and heading acquisition request, and also sends a video image acquisition request to the video image storage unit 11 to acquire video data at the time of acquiring the vehicle position and heading data, the video data being sent thereto from the video image storage unit 11 in response to this video image acquisition request. The details of the process carried out in this step ST11 will be explained below.

Generation of a content is then carried out (step ST12). More specifically, the video image composite processing unit 24 searches for guidance objects in the neighborhood of the vehicle from the map data read from the map database 5 to generate content information to be presented to a user from the guidance objects searched. For example, when the video image composite processing unit is going to command the user to make a right or left turn at an intersection to guide him or her to the destination, the video image composite processing unit generates content information including a character string showing the intersection's name, the coordinates of the intersection, and the coordinates of a route guidance arrow. When the video image composite processing unit is going to provide guidance information about a famous landmark in the neighborhood of the vehicle, the video image composite processing unit generates content information including a character string showing information about the landmark, such as a character string showing the landmark's name, the coordinates of the landmark, and history or tourist attraction regarding the landmark, and business hours, or a photograph of the landmark. As an alternative, the content information can be the coordinates of each road network in the neighborhood of the vehicle, traffic restriction information such as “one-way traffic” or “do not enter” imposed, as a traffic restriction, on each road in the neighborhood of the vehicle, and map information itself including the number of lanes of each road in the neighborhood of the vehicle. The content generation process carried out in this step ST12 will be further explained below in detail.

Each set of coordinates included in the content information are provided as, for example, the latitude and longitude in a coordinate system (referred to as a “reference coordinate system”) determined uniquely on the ground. For example, when a content is a graphic, the coordinates of each vertex of the graphic in the reference coordinate system are provided as the coordinates of the graphic. When a content is a character string or an image, coordinates used as a reference for display of the content are provided as the coordinates of the character string or the image. Through the process of this step ST12, the contents to be presented to the user and the total number a of the contents are decided.

The total number of the contents a is then acquired (step ST13). More specifically, the video image composite processing unit 24 acquires the total number a of the contents generated in step ST12. The value i of a counter is then initialized (step ST14). More specifically, the value i of the counter for counting the number of composited contents is set to “1”. The counter is disposed within the video image composite processing unit 24.

Whether a process of compositing each of all the pieces of content information is completed is then checked to see (step ST15). Concretely, the video image composite processing unit 24 checks to see whether the number i of composite contents which is the value of the counter becomes equal to or larger than the total number a of the contents acquired in step ST13. When it is determined in this step ST15 that the process of compositing each of all the pieces of content information is completed, that is, when it is determined that the number i of composite contents becomes equal to or larger than the total number a of the contents, the video data composited at the time are sent to the display determining unit 25. After that, the content composite video image generating process is ended.

In contrast, when it is determined in step ST15 that the process of compositing each of all the pieces of content information is not completed, that is, when it is determined that the number i of composite contents is smaller than the total number a of the contents, the i-th content information is acquired (step ST16). More specifically, the video image composite processing unit 24 acquires the i-th one of all the pieces of content information generated in step ST12.

The position of the content information on the video image is then calculated using transparent transformation (step ST17). More specifically, the video image composite processing unit 24 uses the vehicle position and heading (the position and heading of the vehicle in the reference coordinate system) acquired in step ST11, the position and heading of the camera 9 in a coordinate system based on the vehicle position, and characteristic values of the camera 9, such as a field angle and a focal length, which are acquired beforehand, so as to calculate the position of the content information acquired in step ST16 on the video image in the reference coordinate system at which the content information is to be displayed. This calculation is the same as coordinate conversion calculation which is called transparent transformation.

An image composite process is then carried out (step ST18). More specifically, the video image composite processing unit 24 superimposes the content such as a graphic, a character string, or an image shown by the content information acquired in step ST16 at the position calculated in step ST17 on the video image acquired in step ST11. The value i of the counter is then incremented (step ST19). More specifically, the video image composite processing unit 24 increments the value of the counter (+1). After that, the sequence returns to step ST15 and the above-mentioned process is repeated.

The video image composite processing unit 24 is configured in such away as to superimpose each content on the video image by using transparent transformation in the above-mentioned content composite video image generating process. As an alternative, the video image composite processing unit can be configured in such a way as to recognize a target within the video image by carrying out an image recognition process on the video image, and then superimpose each content on the target which the video image composite processing unit has recognized.

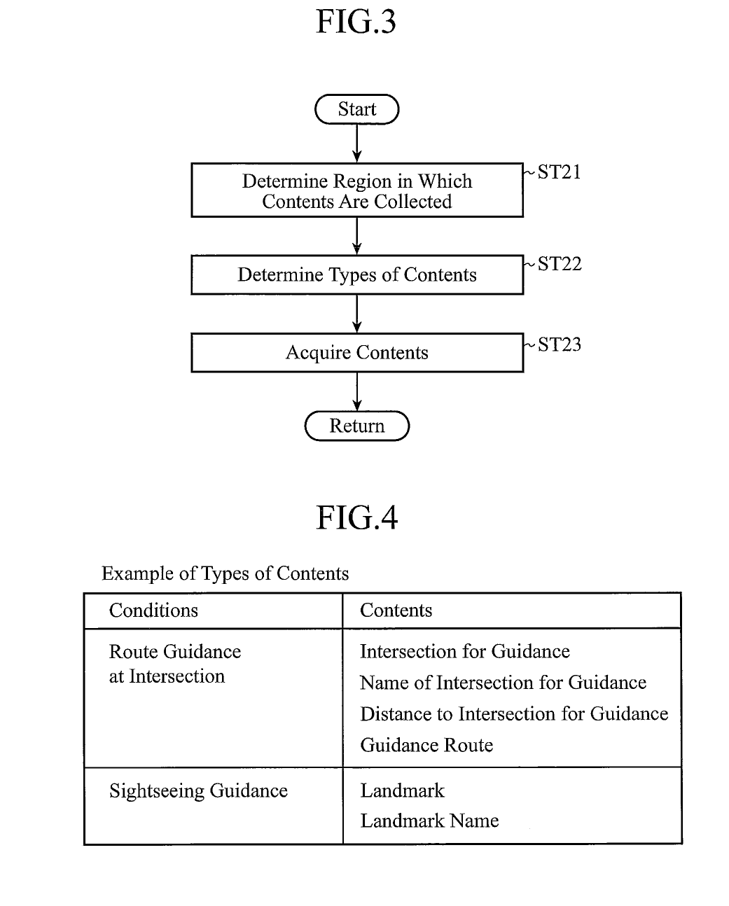

Next, the details of the content generation process carried out in step ST12 of the above-mentioned content composite video image generating processing (refer to FIG. 2) will be explained with reference to a flow chart shown in FIG. 3.

In the content generation process, a region from which contents are to be collected is determined first (step ST21). More specifically, for example, the video image composite processing unit 24 defines, as the region from which contents are to be collected, a region such a circle whose center is at the position of the vehicle, the circle having a radius of 50 m, or a rectangle having a longitudinal side extending from the vehicle and having a length of 50 m, and having a lateral side extending in rightward and leftward directions and having a length of 10 m. As an alternative, the region from which contents are to be collected can be defined in advance by the maker of the navigation device, or can be set up arbitrarily by a user.

The types of contents which are to be collected are then determined (step ST22). The types of contents which are to be collected are defined as types as shown in, for example, FIG. 4, and can vary according to conditions under which the car navigation device provides guidance. The video image composite processing unit 24 determines the types of contents which are to be collected according to conditions under which the car navigation device provides guidance. As an alternative, the types of contents can be defined in advance by the maker of the navigation device, or can be set up arbitrarily by a user.

A collection of contents is then carried out (step ST23). More specifically, the video image composite processing unit 24 acquires contents existing within the region determined in step ST21, and each having one of the types determined in step ST22 from either the map database 5 or another processing unit. After that, the sequence returns to the content composite video image generating processing.

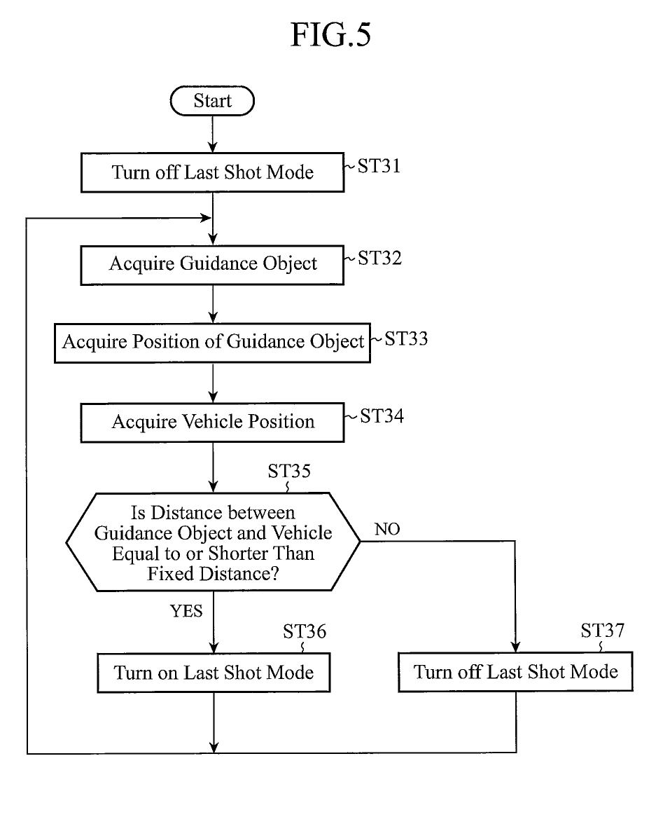

Next, a last shot determining process independently performed in parallel to the above-mentioned content composite video image generating processing will be explained with reference to a flow chart shown in FIG. 5. This last shot determining process is mainly performed by the last shot determining unit 6.

In the last shot determining process, the last shot mode is turned off first (step ST31). More specifically, the last shot determining unit 6 clears a flag for storing information showing the last shot mode which the last shot determining unit holds therein. A guidance object is then acquired (step ST32). More specifically, the last shot determining unit 6 acquires data about a guidance object (e.g. an intersection) from the route determining unit 22 of the navigation control unit 12.

The position of the guidance object is then acquired (step ST33). More specifically, the last shot determining unit 6 acquires the position of the guidance object acquired in step ST32 from the map data read from the map database 5. The vehicle position is then acquired (step ST34). More specifically, the last shot determining unit 6 acquires the vehicle position and heading data from the position and heading measuring unit 4.

Whether or not the distance between the guidance object and the vehicle is equal to or shorter than a fixed distance is then checked to see (step ST35). More specifically, the last shot determining unit 6 determines the distance between the position of the guidance object acquired in step ST33, and the vehicle position shown by the vehicle position and heading data acquired in step ST34, and checks to see whether or not this determined distance is equal to or shorter than the fixed distance. The “fixed distance” is configured in such a way that the maker or a user of the navigation device can set up the fixed distance beforehand.

When it is determined in this step ST35 that the distance between the guidance object and the vehicle is equal to or shorter than the fixed distance, the last shot mode is turned on (step ST36). More specifically, when the distance between the guidance object and the vehicle is equal to or shorter than the fixed distance, the last shot determining unit 6 generates a last shot mode signal showing turning on of the last shot mode, and sends the last shot mode signal to the position and heading storage unit 7 and the video image storage unit 11. After that, the sequence returns to step ST32 and the above-mentioned processing is repeated.

In contrast, when it is determined in step ST35 that the distance between the guidance object and the vehicle is not equal to or shorter than the fixed distance, the last shot mode is turned off (step ST37). More specifically, when the distance between the guidance object and the vehicle is longer than the fixed distance, the last shot determining unit 6 generates a last shot mode signal showing turning off of the last shot mode, and sends the last shot mode signal to the position and heading storage unit 7 and the video image storage unit 11. After that, the sequence returns to step ST32 and the above-mentioned processing is repeated.

The car navigation device is configured in such a way as to turn off the last shot mode when the distance between the guidance object and the vehicle stopped is not equal to or shorter than the fixed distance in the above-mentioned last shot determining process. The car navigation device can be alternatively configured in such a way as to turn off the last shot mode when the guidance object goes into a region having 180 degrees behind the vehicle, when a fixed time interval predetermined by the maker or a user of the navigation device has elapsed, or when the guidance object goes into the region having 180 degrees and the fixed time interval has elapsed.

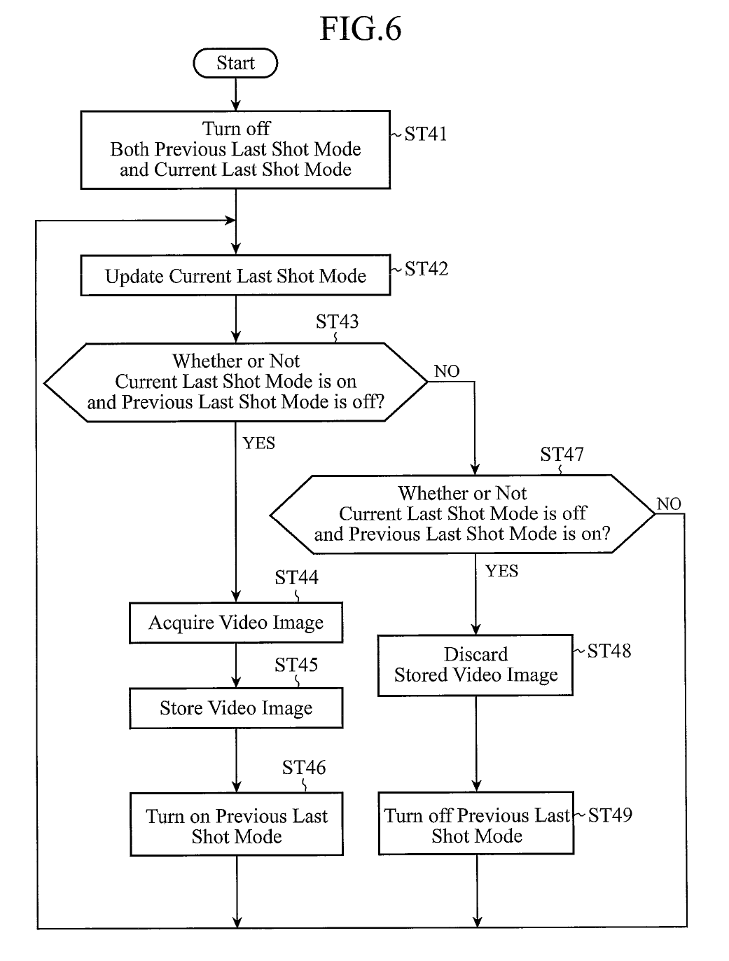

Next, a video image storage process independently performed in parallel to the above-mentioned content composite video image generating processing will be explained with reference to a flow chart shown in FIG. 6. This video image storage process is mainly performed by the video image storage unit 11. The video image storage unit 11 has an internal state which can be an ON one or an OFF one for each of a previous last shot mode and a current last shot mode.

In the video image storage process, both the current last shot mode and the previous last shot mode are turned off first (step ST41). More specifically, the video image storage unit 11 clears both a flag for storing information showing the previous last shot mode which the video image storage unit holds therein, and a flag for storing information showing the current last shot mode. The current last shot mode is then updated (step ST42). More specifically, the video image storage unit 11 acquires a last shot mode signal from the last shot determining unit 6, and defines the last shot mode shown by this acquired last shot mode signal as the current last shot mode.

Whether or not the current last shot mode is in the on state and the previous last shot mode is in the off state is then checked to see (step ST43). More specifically, the video image storage unit 11 checks to see whether or not the last shot mode shown by the last shot mode signal acquired in step ST43 is in the on state and the previous last shot mode which the video image storage unit holds therein is in the off state.

When it is determined in this step ST43 that the current last shot mode is in the on state and the previous last shot mode is in the off state, the video image is acquired (step ST44). More specifically, the video image storage unit 11 acquires the video data from the video image acquiring unit 10. The video image is then stored (step ST45). More specifically, the video image storage unit 11 stores the video data acquired in step ST44 therein. The previous last shot mode is then turned on (step ST46). More specifically, the video image storage unit 11 turns on the previous last shot mode which the video image storage unit holds therein. In this state, the video image storage unit 11 maintains the stored video data. After that, the sequence returns to step ST42 and the above-mentioned process is repeated.

When it is determined in above-mentioned step ST43 that the current last shot mode is not in the on state or the previous last shot mode is not in the off state, it is then checked to see whether or not the current last shot mode is in the off state and the previous last shot mode is in the on state (step ST47). More specifically, the video image storage unit 11 checks to see whether or not the last shot mode shown by the last shot mode signal acquired in step ST43 is in the off state and the previous last shot mode which the video image storage unit holds therein is in the on state.

When it is determined in this step ST47 that the current last shot mode is not in the off state or the previous last shot mode is not in the on state, the sequence returns to step ST42 and the above-mentioned process is repeated. In contrast, when it is determined in step ST47 that the current last shot mode is in the off state and the previous last shot mode is in the on state, the video image stored is then discarded (step ST48). More specifically, the video image storage unit 11 discards the video data which the video image storage unit stores therein. The previous last shot mode is then turned off (step ST49). More specifically, the video image storage unit 11 turns off the previous last shot mode which the video image storage unit holds therein. In this state, the video image storage unit 11 sends out the video data sent thereto from the video image acquiring unit 10 to the video image composite processing unit 24 just as it is. After that, the sequence returns to step ST42 and the above-mentioned process is repeated.

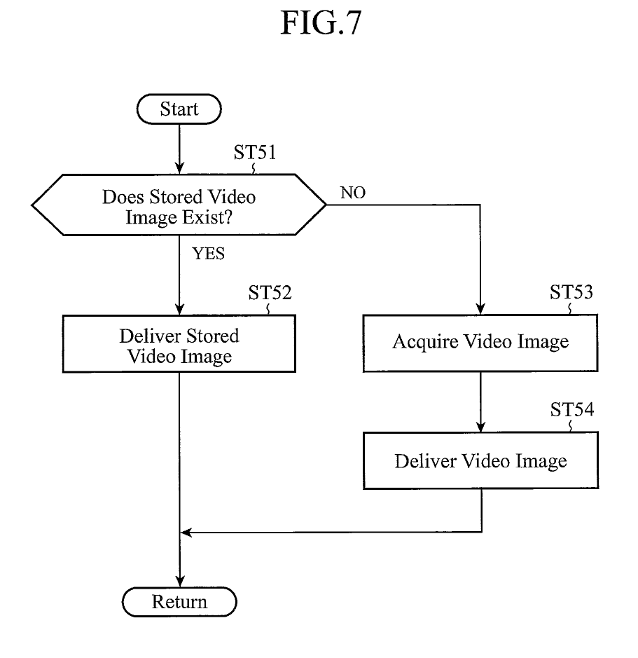

Next, the video image acquisition process performed in step ST11 of the above-mentioned content composite video image generating processing will be explained with reference to a flow chart shown in FIG. 7. This video image acquisition process is mainly performed by the video image storage unit 11.

In the video image acquisition process, it is first checked to see whether or not there is a video image stored (step ST51). More specifically, the video image storage unit 11 checks to see or not whether the video image storage unit stores video data therein in response to a video image acquisition request from the video image composite processing unit 24. When it is determined in this step ST51 that there is a video image stored, the video image stored is delivered (step ST52). More specifically, the video image storage unit 11 sends the video data which the video image storage unit stores therein to the video image composite processing unit 24. After that, the video image acquisition process is ended and the sequence returns to the content composite video image generating processing.

In contrast, when it is determined in step ST51 that there is no video image stored, the video image is then acquired (step ST53). More specifically, the video image storage unit 11 acquires the video data from the video image acquiring unit 10. The video image acquired is then delivered (step ST54). More specifically, the video image storage unit 11 sends the video data acquired in step ST53 to the video image composite processing unit 24. After that, the video image acquisition process is ended and the sequence returns to the content composite video image generating processing.

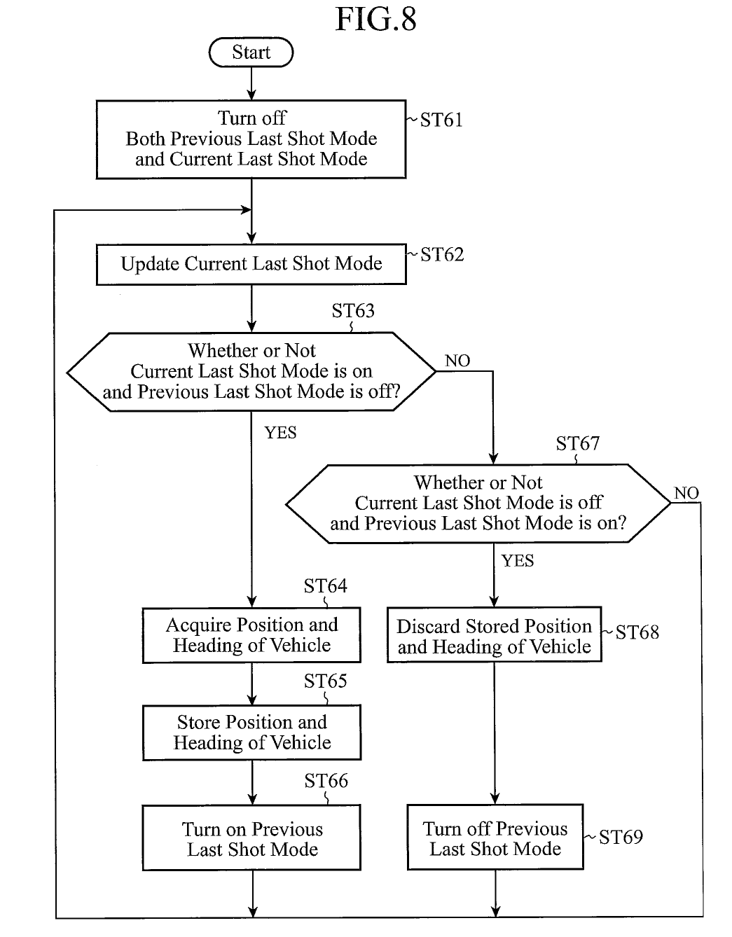

Next, the vehicle position and heading storage process independently performed in parallel to the above-mentioned content composite video image generating processing will be explained with reference to a flow chart shown in FIG. 8. This vehicle position and heading storage process is mainly performed by the position and heading storage unit 7. The position and heading storage unit 7 has an internal state which can be an on one or an off one for each of the previous last shot mode and the current last shot mode.

In the vehicle position and heading storage process, both the current last shot mode and the previous last shot mode are turned off first (step ST61). More specifically, the position and heading storage unit 7 clears both a flag for storing the information showing the previous last shot mode which the position and heading storage unit holds therein, and a flag for storing the information showing the current last shot mode. The current last shot mode is then updated (step ST62). More specifically, the position and heading storage unit 7 acquires the last shot mode signal from the last shot determining unit 6 and defines the last shot mode shown by this acquired last shot mode signal as the current last shot mode.

Whether or not the current last shot mode is in the on state and the previous last shot mode is in the off state is then checked to see (step ST63). More specifically, the position and heading storage unit 7 checks to see whether or not the last shot mode shown by the last shot mode signal acquired in step ST63 is in the on state and the previous last shot mode which the position and heading storage unit holds therein is in the off state.

When it is determined in this step ST63 that the current last shot mode is in the on state and the previous last shot mode is in the off state, the position and heading of the vehicle are acquired (step ST64). More specifically, the position and heading storage unit 7 acquires the vehicle position and heading data from the position and heading measuring unit 4. The position and heading of the vehicle are then stored (step ST65). More specifically, the position and heading storage unit 7 stores the vehicle position and heading data acquired in step ST64 therein. The previous last shot mode is then turned on (step ST66). More specifically, the position and heading storage unit 7 turns on the previous last shot mode which the position and heading storage unit holds therein. In this state, the position and heading storage unit 6 maintains the stored vehicle position and heading data. After that, the sequence returns to step ST62 and the above-mentioned process is repeated.

When it is determined in above-mentioned step ST63 that the current last shot mode is not in the on state or the previous last shot mode is not in the off state, it is then checked to see whether or not the current last shot mode is in the off state and the previous last shot mode is in the on state (step ST67). More specifically, the position and heading storage unit 7 checks to see whether or not the last shot mode shown by the last shot mode signal acquired in step ST63 is in the off state and the previous last shot mode which the position and heading storage unit holds therein is in the on state

When it is determined in this step ST67 that the current last shot mode is not in the off state or the previous last shot mode is not in the on state, the sequence returns to step ST62 and the above-mentioned process is repeated. In contrast, when it is determined in step ST67 that the current last shot mode is in the off state and the previous last shot mode is in the on state, the vehicle heading information stored is then discarded (step ST68). More specifically, the position and heading storage unit 7 discards the vehicle position and heading data which the position and heading storage unit stores therein. The previous last shot mode is then turned off (step ST69). More specifically, the position and heading storage unit 7 turns off the previous last shot mode which the position and heading storage unit holds therein. In this state, the position and heading storage unit 6 sends out the vehicle position and heading data sent thereto from the position and heading measuring unit 4 to the video image composite processing unit 24 just as it is. After that, the sequence returns to step ST62 and the above-mentioned process is repeated.

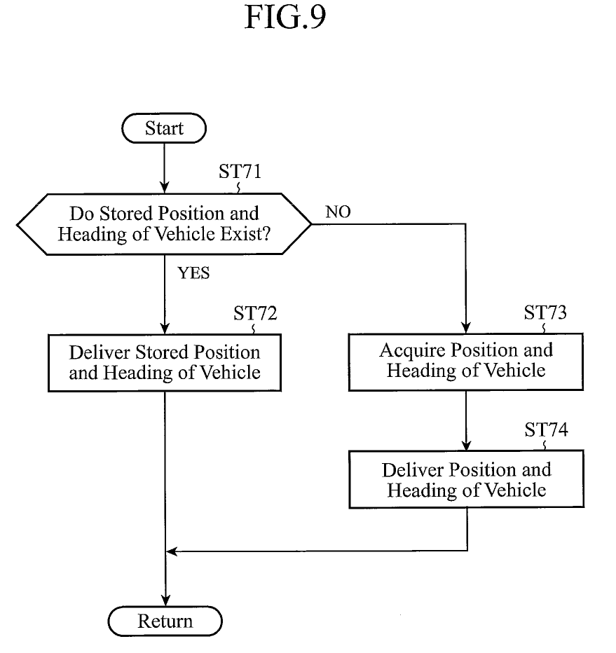

Next, the position and heading acquiring process performed in step ST11 of the above-mentioned content composite video image generating processing will be explained with reference to a flow chart shown in FIG. 9. This position and heading acquiring process is mainly performed by the position and heading storage unit 7.

In the position and heading acquiring process, whether there exists a stored position and a stored heading of the vehicle is checked to see first (step ST71). More specifically, the position and heading storage unit 7 checks to see whether or not vehicle position and heading data are stored therein in response to a position and heading acquisition request from the video image composite processing unit 24. When it is determined in this step ST71 that there exists a stored position and a stored heading of the vehicle, the stored position and heading of the vehicle are informed (step ST72). More specifically, the position and heading storage unit 7 sends the vehicle position and heading data which the position and heading storage unit stores therein to the video image composite processing unit 24. After that, the position and heading acquiring process is ended and the sequence returns to the content composite video image generating processing.

In contrast, when it is determined in step ST71 that there exists no stored position and stored heading of the vehicle, the position and heading of the vehicle are then acquired (step ST73). More specifically, the position and heading storage unit 7 acquires the vehicle position and heading data from the position and heading measuring unit 4. The acquired position and heading of the vehicle are then informed (step ST74). More specifically, the position and heading storage unit 7 sends the vehicle position and heading data acquired in step ST73 to the video image composite processing unit 24. After that, the position and heading acquiring process is ended and the sequence returns to the content composite video image generating processing.

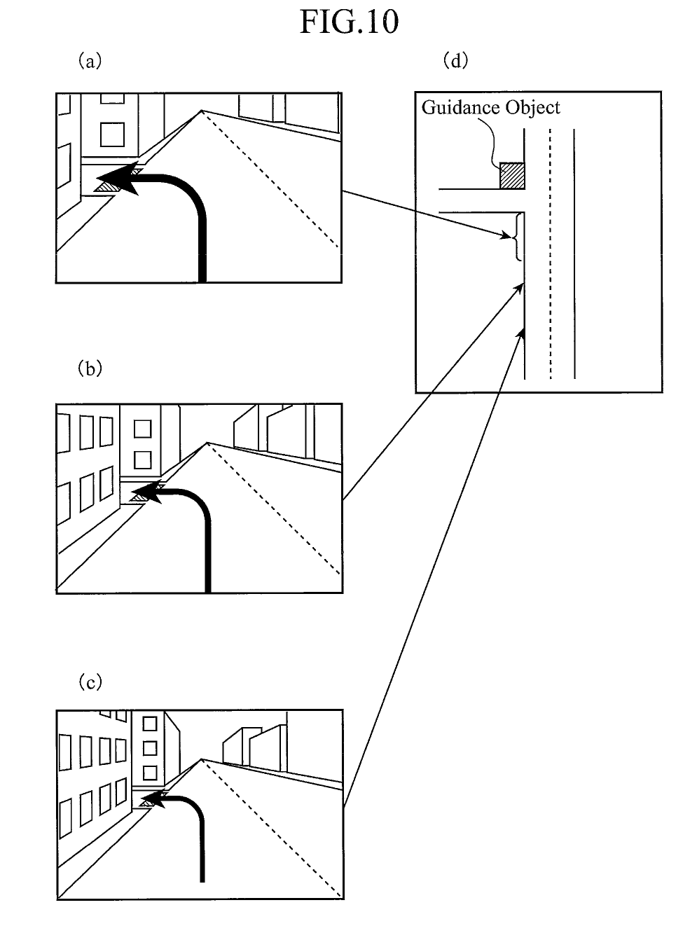

FIG. 10 is a view showing an example of the on-the-spot guide view displayed on the screen of the display unit 13 in the navigation device in accordance with Embodiment 1 of the present invention. Hereafter, a case in which neighboring roads and a guidance object (a rectangle shown by hatch lines) as shown in FIG. 10 (d) are informed as guidance will be examined. In a case in which the guidance object is at a fixed distance or longer from the vehicle position and is far from the vehicle, a video image acquired in real time as shown in FIG. 10 (c) is displayed on the screen of the display unit 13. In contrast, in a case in which the guidance object is at a fixed distance or longer from the vehicle position, but is near to the vehicle, a video image acquired in real time as shown in FIG. 10(b) is displayed on the screen of the display unit 13. When the guidance object reaches a position at the fixed distance or less from the vehicle, a video image as shown in FIG. 10 (a) is captured as the last shot video image, and guidance using the same last shot video image is carried out until the vehicle is at a certain distance or longer from the guidance object.

As previously explained, the navigation device in accordance with Embodiment 1 of the present invention is configured in such a way as to, when the vehicle is at a fixed distance or shorter from a guidance object, switch to the last shot mode in which the navigation device fixedly and continuously outputs a video image which the navigation device acquires at that time. Therefore, because the navigation device in accordance with Embodiment 1 of the present invention can prevent a video image unsuitable for guidance, e.g. a video image including a guidance object partially extending off screen when the vehicle approaches the guidance object too much from being displayed, the navigation device makes the display of the video image legible, and can present proper information to a user when the vehicle approaches a guidance object such as an intersection.

The navigation device in accordance with above-mentioned Embodiment 1 is explained by taking, as an example, the case in which one guidance object exists at a fixed distance or shorter from the vehicle. The navigation device in accordance with above-mentioned Embodiment 1 can be configured in such a way as to, when two or more guidance objects exist at a fixed distance or shorter from the vehicle, select one of the guidance objects according to the priorities assigned to the guidance objects in advance and use a video image including the selected guidance object as the last shot video image.

Furthermore, the navigation device in accordance with above-mentioned Embodiment 1 is configured in such a way that the video image acquiring unit 10 generates video data showing a three-dimensional video image and sends the generated video data showing the three-dimensional video image to the video image storage unit 11 by converting an image signal sent thereto from the camera 9 into a digital signal. The video image acquiring unit 10 can be alternatively configured in such a way as to send video data showing a three-dimensional video image generated by, for example, the navigation control unit 12 or the like using CG to the video image storage unit 11. Also in this case, the navigation device provides the same actions and advantages as those provided by the navigation device in accordance with above-mentioned Embodiment 1.

### Embodiment 2

A navigation device in accordance with Embodiment 2 of the present invention has the same configuration as the navigation device in accordance with Embodiment 1 shown in FIG. 1, except for the function of a last shot determining unit 6, concretely, a criterion by which to determine whether to switch to a last shot mode.

The last shot determining unit 6 determines whether to switch to the last shot mode by using route guidance data sent thereto from a route determining unit 22, vehicle position and heading data sent thereto from a position and heading measuring unit 4, and map data acquired from a map database 5. At this time, the last shot determining unit 6 changes a certain distance which defines a time at which to switch to the last shot mode according to the size of a guidance object.

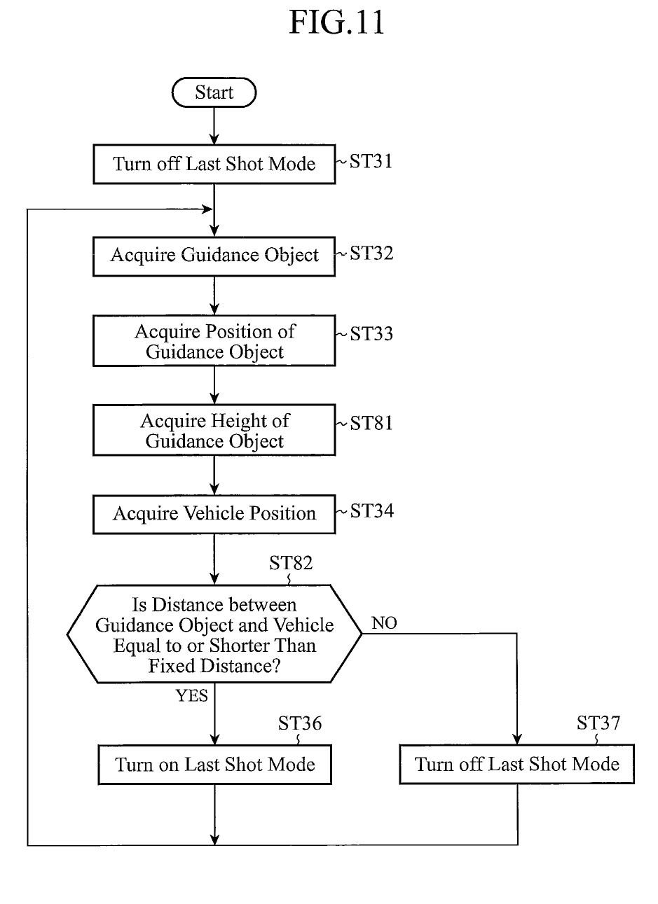

Next, the operation of the navigation device in accordance with Embodiment 2 of the present invention configured as mentioned above will be explained. The operation of this navigation device is the same as that of the navigation device in accordance with Embodiment 1 except for a last shot determining process (refer to FIG. 5). Hereafter, the details of the last shot determining process will be explained with reference to a flow chart shown in FIG. 11. The same reference characters as those used in Embodiment 1 are attached to the same steps as those of the last shot determining process carried out by the navigation device in accordance with Embodiment 1, and the explanation of the steps will be simplified hereafter.

In the last shot determining process, the last shot mode is turned off first (step ST31). A guidance object is then acquired (step ST32). The position of the guidance object is then acquired (step ST33). The height of the guidance object is then acquired (step ST81). More specifically, the last shot determining unit 6 acquires the height h [m] of the guidance object acquired in step ST32 from the map data read from the map database 5. The vehicle position is then acquired (step ST34).

Whether or not the distance between the guidance object and the vehicle is equal to or shorter than a fixed distance is then checked to see (step ST82). More specifically, the last shot determining unit 6 determines the distance d [m] between the guidance object acquired in step ST32 and the vehicle position shown by the vehicle position and heading data acquired in step ST34, and checks to see whether or not this determined distance d [m] is equal to or shorter than the fixed distance. In this case, the fixed distance is determined from a distance D which the maker or a user of the navigation device sets up beforehand and the height h [m] acquired in step ST81 according to the following equation (1).

D*(1+h/100) (1)

When it is determined in this step ST82 that the distance between the guidance object and the vehicle is equal to or shorter than the fixed distance, that is, when “d≦D*(1+h/100)” is established, the last shot mode is turned on (step ST36). After that, the sequence returns to step ST32 and the above-mentioned process is repeated. In contrast, when it is determined in step ST82 that the distance between the guidance object and the vehicle is not equal to or shorter than the fixed distance, that is, when “d>D*(1+h/100)” is established, the last shot mode is turned off (step ST37). After that, the sequence returns to step ST32 and the above-mentioned process is repeated.

The car navigation device is configured in such a way as to turn off the last shot mode when the distance between the guidance object and the vehicle is not equal to or shorter than the fixed distance in the above-mentioned last shot determining process. The car navigation device can be alternatively configured in such a way as to turn off the last shot mode when the guidance object goes into a region having 180 degrees behind the vehicle, when a fixed time interval predetermined by the maker or a user of the navigation device has elapsed, or when the guidance object goes into the region having 180 degrees and the fixed time interval has elapsed.

The car navigation device is configured in such a way as to, in the process of step ST82 of FIG. 11, determine whether to turn on or off the last shot mode by assuming the height of the guidance object as the size of the guidance object, though the car navigation device can be alternatively configured in such a way as to determine whether to turn on or off the last shot mode by using, as the size of the guidance object, information other than the height of the guidance object, e.g. the base area of the guidance object or the number of stories of the guidance object which is a building. Furthermore, an approximate size is predetermined for each of genres of guidance objects (for each of hotel, convenience store, intersection, and so on) , and the car navigation device can be configured in such a way as to use these genres for indirect determination of whether to turn on or off the last shot mode.

Furthermore, in step ST82 of FIG. 11, instead of using the distance which is obtained by lengthening the distance D [m] set up beforehand as the fixed distance, a distance which is obtained by shortening the distance D [m] set up beforehand by using, for example, the following equation: “D*(1+(h−10)/100)” can be used (in this case, the shortened distance becomes smaller than D at the time of h<10).

As previously explained, the navigation device in accordance with Embodiment 2 of the present invention is configured in such a way as to determine whether to turn on or off the last shot mode according to the size of a guidance object. When the guidance object is large, the navigation device in accordance with Embodiment 2 of the present invention switches to guidance using the last shot video image when the vehicle is at a relatively-long distance from the guidance object. In contrast, when the guidance object is small, the navigation device in accordance with Embodiment 2 of the present invention switches to guidance using the last shot video image when the vehicle is at a close distance to the guidance object. As a result, the navigation device in accordance with Embodiment 2 of the present invention can acquire the last shot video image in which the guidance object always fits the screen.

### Embodiment 3

A navigation device in accordance with Embodiment 3 of the present invention has the same configuration as the navigation device in accordance with Embodiment 1 shown in FIG. 1, except for the function of a last shot determining unit 6, concretely, a criterion by which to determine whether to switch to a last shot mode.

The last shot determining unit 6 determines whether to switch to the last shot mode by using route guidance data sent thereto from a route determining unit 22, vehicle position and heading data sent thereto from a position and heading measuring unit 4, and map data acquired from a map database 5. At this time, the last shot determining unit 6 changes a distance which defines a time at which to switch to a last shot video image according to the conditions of a road along which the vehicle is traveling, e.g. the number of lanes, the type of the road (highway, national road, street, or the like), or the degree of curvature of the road.

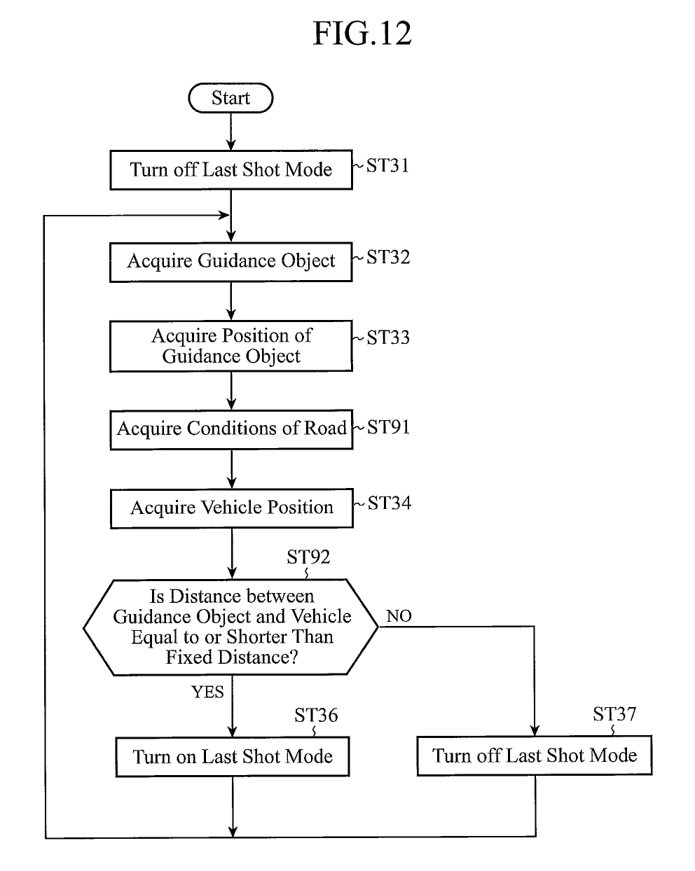

Next, the operation of the navigation device in accordance with Embodiment 3 of the present invention configured as mentioned above will be explained. The operation of this navigation device is the same as that of the navigation device in accordance with Embodiment 1 except for a last shot determining process (refer to FIG. 5). Hereafter, the details of the last shot determining process will be explained with reference to a flow chart shown in FIG. 12. The same reference characters as those used in Embodiment 1 are attached to the same steps as those of the last shot determining process carried out by the navigation device in accordance with Embodiment 1, and the explanation of the steps will be simplified hereafter. Hereafter, the explanation will be made by taking the “number of lanes” as an example of “the conditions of the road”.

In the last shot determining process, the last shot mode is turned off first (step ST31). A guidance object is then acquired (step ST32). The position of the guidance object is then acquired (step ST33). The conditions of the road are then acquired (step ST91). More specifically, the last shot determining unit 6 acquires the number n of lanes [number] from the map data read from the map database 5 as information showing the conditions of the road. The vehicle position is then acquired (step ST34).

Whether or not the distance between the guidance object and the vehicle is equal to or shorter than a fixed distance is then checked to see (step ST92). More specifically, the last shot determining unit 6 determines the distance d [m] between the guidance object acquired in step ST32 and the vehicle position shown by the vehicle position and heading data acquired in step ST34, and checks to see whether or not this determined distance d [m] is equal to or shorter than the fixed distance. In this case, the fixed distance is determined from a distance D which the maker or a user of the navigation device sets up beforehand and the number n of lanes [number] acquired in step ST91 according to the following equation (2).

D*(1+n) (2)

When it is determined in this step ST92 that the distance between the guidance object and the vehicle is equal to or shorter than the fixed distance, that is, when “d≦D*(1+n)” is established, the last shot mode is turned on (step ST36). After that, the sequence returns to step ST32 and the above-mentioned process is repeated. In contrast, when it is determined in step ST92 that the distance between the guidance object and the vehicle is not equal to or shorter than the fixed distance, that is, when “d>D*(1+n)” is established, the last shot mode is turned off (step ST37). After that, the sequence returns to step ST32 and the above-mentioned process is repeated.

The car navigation device is configured in such a way as to turn off the last shot mode when the distance between the guidance object and the vehicle is not equal to or shorter than the fixed distance in the above-mentioned last shot determining process. The car navigation device can be alternatively configured in such a way as to turn off the last shot mode when the guidance object goes into a region having 180 degrees behind the vehicle, when a fixed time interval predetermined by the maker or a user of the navigation device has elapsed, or when the guidance object goes into the region having 180 degrees and the fixed time interval has elapsed.

The car navigation device is configured in such a way as to, in the process of step ST92 of FIG. 12, determine whether to turn on or off the last shot mode by assuming the number of lanes as the conditions of the road, though the car navigation device can be alternatively configured in such a way as to determine whether to turn on or off the last shot mode according to the conditions of the road other than the number of lanes, e.g. the type of the road by changing the distance D in such a way that the distance D is multiplied by a factor of 2 in a case in which the vehicle is traveling along a highway, and the distance D is used just as it is in a case in which the vehicle is traveling along a street. As an alternative, the car navigation device can be configured in such a way as to determine whether to turn on or off the last shot mode according to the degree of curvature of the road by determining how many times the distance D is magnified dependently upon the degree of curvature of the road.

Furthermore, in step ST92 of FIG. 12, instead of using the distance which is obtained by lengthening the distance D [m] set up beforehand as the fixed distance, a distance which is obtained by shortening the distance D [m] set up beforehand by using, for example, the following equation: “d≦D*(1+(n−2)*0.5)” can be used (in this case, when the number of lanes n=1, the fixed distance is D*0.5 and is smaller than D).

As explained above, the navigation device in accordance with Embodiment 3 of the present invention is configured in such a way as to change the distance at which to turn on the last shot mode according to the conditions of the road. Therefore, while the vehicle travels a road with good visibility, the navigation device in accordance with Embodiment 3 of the present invention can switch to the last shot video image even when the vehicle is far away from the guidance object. As a result, for example, the navigation device in accordance with Embodiment 3 of the present invention can implement a function of, while the vehicle travels along a wide road, switching to the last shot video image even when the vehicle is far away from the guidance object, and, when the vehicle goes out of a curved road portion and then enters a straight road portion before the guidance object, switching to the last shot video image.

### Embodiment 4

A navigation device in accordance with Embodiment 4 of the present invention has the same configuration as the navigation device in accordance with Embodiment 1 shown in FIG. 1, except for the function of a last shot determining unit 6, concretely, a criterion by which to determine whether to switch to a last shot mode.

The last shot determining unit 6 determines whether to switch to the last shot mode by using route guidance data sent thereto from a route determining unit 22, vehicle position and heading data sent thereto from a position and heading measuring unit 4, and map data acquired from a map database 5. At this time, the last shot determining unit 6 changes a distance which defines a time at which to switch to a last shot video image according to the speed of the vehicle. The speed of the vehicle corresponds to the “traveling speed of the navigation device itself” of the present invention.

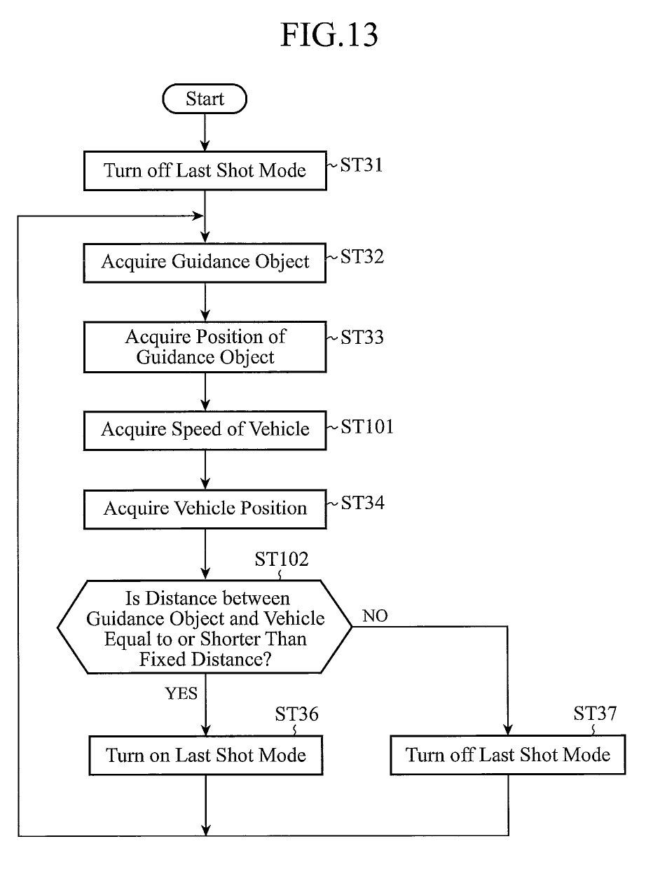

Next, the operation of the navigation device in accordance with Embodiment 4 of the present invention configured as mentioned above will be explained. The operation of this navigation device is the same as that of the navigation device in accordance with Embodiment 1 except for a last shot determining process (refer to FIG. 5). Hereafter, the details of the last shot determining process will be explained with reference to a flow chart shown in FIG. 13. The same reference characters as those used in Embodiment 1 are attached to the same steps as those of the last shot determining process carried out by the navigation device in accordance with Embodiment 1, and the explanation of the steps will be simplified hereafter.

In the last shot determining process, the last shot mode is turned off first (step ST31). A guidance object is then acquired (step ST32). The position of the guidance object is then acquired (step ST33). The speed of the vehicle is then acquired (step ST101). More specifically, the last shot determining unit 6 acquires the vehicle speed v [km/h] which is the speed of the vehicle from a speed sensor 2 via a position and heading measuring unit 4. The vehicle position is then acquired (step ST34).

Whether or not the distance between the guidance object and the vehicle is equal to or shorter than a fixed distance is then checked to see (step ST102). More specifically, the last shot determining unit 6 determines the distance d [m] between the guidance object acquired in step ST32 and the vehicle position shown by the vehicle position and heading data acquired in step ST34, and checks to see whether or not this determined distance d [m] is equal to or shorter than the fixed distance. In this case, the fixed distance is determined from a distance D which the maker or a user of the navigation device sets up beforehand and the vehicle speed v [km/h] acquired in step ST101 according to the following equation (3).

D*(1+v/100) (3)

When it is determined in this step ST102 that the distance between the guidance object and the vehicle is equal to or shorter than the fixed distance, that is, when “d≦D*(1+v/100)” is established, the last shot mode is turned on (step ST36). After that, the sequence returns to step ST32 and the above-mentioned process is repeated. In contrast, when it is determined in step ST102 that the distance between the guidance object and the vehicle is not equal to or shorter than the fixed distance, that is, when “d>D*(1+v/100)” is established, the last shot mode is turned off (step ST37). After that, the sequence returns to step ST32 and the above-mentioned process is repeated.

The car navigation device is configured in such a way as to turn off the last shot mode when the distance between the guidance object and the vehicle is not equal to or shorter than the fixed distance in the above-mentioned last shot determining process. The car navigation device can be alternatively configured in such a way as to turn off the last shot mode when the guidance object goes into a region having 180 degrees behind the vehicle, when a fixed time interval predetermined by the maker or a user of the navigation device has elapsed, or when the guidance object goes into the region having 180 degrees and the fixed time interval has elapsed.

Furthermore, in step ST102 of FIG. 13, instead of using the distance which is obtained by lengthening the distance D [m] set up beforehand as the fixed distance, a distance which is obtained by shortening the distance D [m] set up beforehand can be used.

As explained above, the navigation device in accordance with Embodiment 4 of the present invention is configured in such a way as to change the distance at which to turn on the last shot mode according to the vehicle speed. Therefore, the navigation device in accordance with Embodiment 4 of the present invention can implement a function of switching to the last shot video image at an earlier time while the vehicle travels at a high speed.

### Embodiment 5

A navigation device in accordance with Embodiment 5 of the present invention has the same configuration as the navigation device in accordance with Embodiment 1 shown in FIG. 1, except for the function of a last shot determining unit 6, concretely, a criterion by which to determine whether to switch to a last shot mode.

The last shot determining unit 6 determines whether to switch to the last shot mode by using route guidance data sent thereto from a route determining unit 22, vehicle position and heading data sent thereto from a position and heading measuring unit 4, and map data acquired from a map database 5. At this time, the last shot determining unit 6 changes a distance which defines a time at which to switch to a last shot video image according to the surrounding conditions of an area surrounding the vehicle (weather, day or night, and whether or not another vehicle is existing frontwardly).

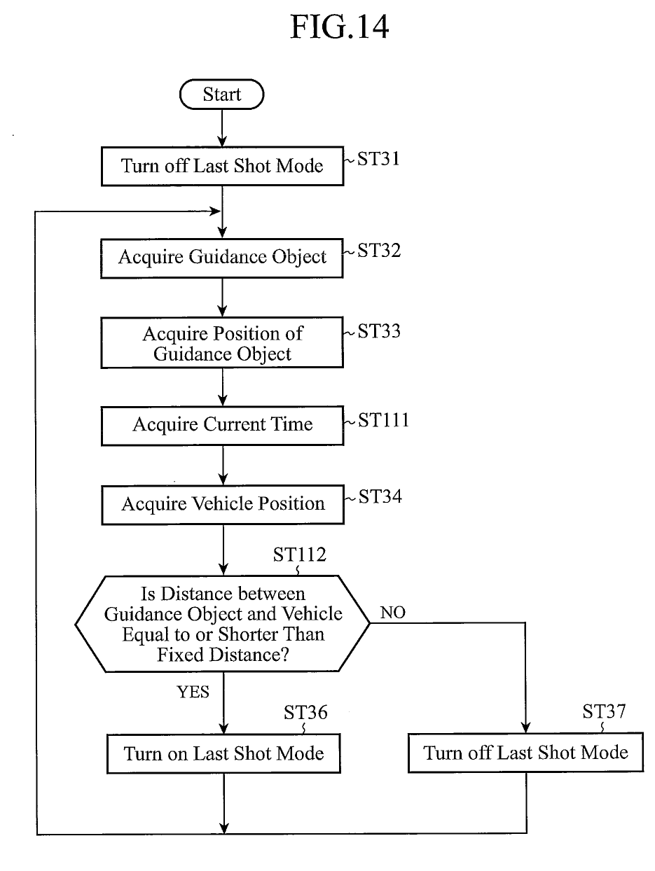

Next, the operation of the navigation device in accordance with Embodiment 5 of the present invention configured as mentioned above will be explained. The operation of this navigation device is the same as that of the navigation device in accordance with Embodiment 1 except for a last shot determining process (refer to FIG. 5). Hereafter, the details of the last shot determining process will be explained with reference to a flow chart shown in FIG. 14. The same reference characters as those used in Embodiment 1 are attached to the same steps as those of the last shot determining process carried out by the navigation device in accordance with Embodiment 1, and the explanation of the steps will be simplified hereafter. Hereafter, the explanation will be made by taking a “time zone” as an example of the “surrounding conditions”.

In the last shot determining process, the last shot mode is turned off first (step ST31). A guidance object is then acquired (step ST32). The position of the guidance object is then acquired (step ST33). The current time is then acquired (step ST111). More specifically, the last shot determining unit 6 acquires the current time from a not-shown time register. The vehicle position is then acquired (step ST34).

Whether or not the distance between the guidance object and the vehicle is equal to or shorter than a fixed distance is then checked to see (step ST112). More specifically, the last shot determining unit 6 determines the distance d [m] between the guidance object acquired in step ST32 and the vehicle position shown by the vehicle position and heading data acquired in step ST34, and checks to see whether or not this determined distance d [m] is equal to or shorter than the fixed distance. In this case, the fixed distance is determined from a distance D which the maker or a user of the navigation device sets up beforehand and the current time acquired in step ST111. For example, when the current time is in the nighttime, the fixed distance is calculated by adding a small value to the distance D, whereas when the current time is in the daytime, the fixed distance is calculated by adding a large value to the distance D.

When it is determined in this step ST112 that the distance between the guidance object and the vehicle is equal to or shorter than the fixed distance, the last shot mode is turned on (step ST36). After that, the sequence returns to step ST32 and the above-mentioned process is repeated. In contrast, when it is determined in step ST112 that the distance between the guidance object and the vehicle is not equal to or shorter than the fixed distance, the last shot mode is turned off (step ST37). After that, the sequence returns to step ST32 and the above-mentioned process is repeated.

The car navigation device is configured in such a way as to turn off the last shot mode when the distance between the guidance object and the vehicle is not equal to or shorter than the fixed distance in the above-mentioned last shot determining process. The car navigation device can be alternatively configured in such a way as to turn off the last shot mode when the guidance object goes into a region having 180 degrees behind the vehicle, when a fixed time interval predetermined by the maker or a user of the navigation device has elapsed, or when the guidance object goes into the region having 180 degrees and the fixed time interval has elapsed.

The car navigation device is configured in such a way as to, in the process of step ST112 of FIG. 14, determine whether to turn on or off the last shot mode by assuming the time zone as the surrounding conditions of the vehicle, though the car navigation device can be alternatively configured in such a way as to determine whether to turn on or off the last shot mode according to the surrounding conditions of the vehicle other than the time zone, e.g. the weather by changing the distance D in such a way that the distance D is multiplied by a factor of 2 in the case in which it is fine or cloudy, and the distance D is used just as it is in the case in which it is raining or snowing. As an alternative, the car navigation device can be configured in such a way as to determine whether to turn on or off the last shot mode by changing the distance D using the result of determination of whether or not another vehicle is existing frontwardly from the vehicle by means of a millimeter wave radar or image analysis. The car navigation device can be alternatively configured in such a way as to determine whether to turn on or off the last shot mode by using a combination of these determination criteria.

As explained above, because the navigation device in accordance with Embodiment 5 of the present invention is configured in such a way as to change the distance at which to turn on the last shot mode according to the surrounding conditions of the vehicle, the navigation device in accordance with Embodiment 5 of the present invention can implement a function of switching to the last shot video image at an earlier time when the vehicle is traveling along a road with good visibility, while not switching to the last shot video image until the vehicle sufficiently approaches the guidance object unless the driver has an unobstructed view of the road because, for example, it is raining, he or she is driving in the nighttime, or a truck is traveling frontwardly.

### Embodiment 6

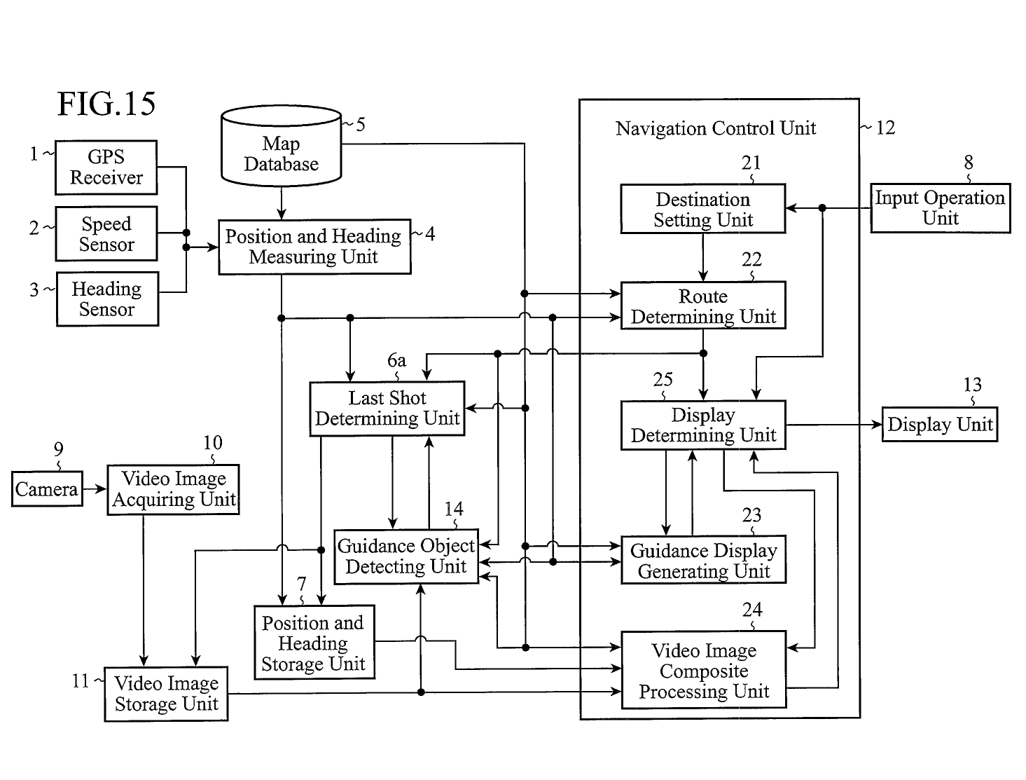

FIG. 15 is a block diagram showing the configuration of a navigation device in accordance with Embodiment 6 of the present invention. This navigation device is configured in such a way that a guidance object detecting unit 14 is added to the components of the navigation device in accordance with Embodiment 1, and the last shot determining unit 6 is replaced by a last shot determining unit 6a.

The guidance object detecting unit 14 detects whether or not a guidance object is included in a video image acquired from a video image storage unit 11 in response to a request from the last shot determining unit 6a, and returns the result of the detection to the last shot determining unit 6a.

The last shot determining unit 6a determines whether or not to switch guidance to be presented to a user to a last shot mode on the basis of route guidance data sent thereto from a route determining unit 22, vehicle position and heading data sent thereto from a position and heading measuring unit 4, map data acquired from a map database 5 and the result of the determination of whether or not a guidance object is included in the video image acquired, which is acquired from the guidance object detecting unit 14.

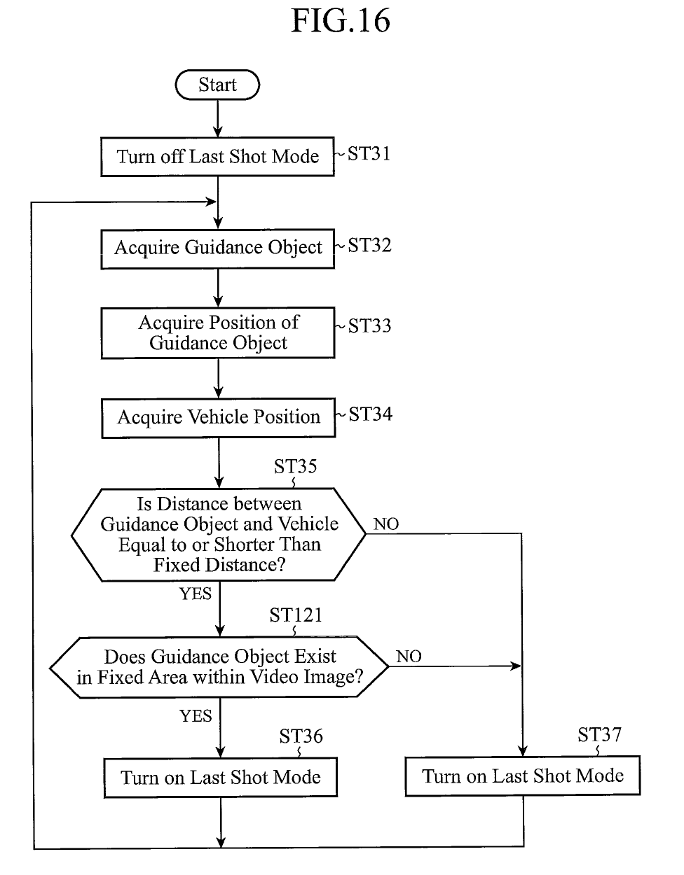

Next, the operation of the navigation device in accordance with Embodiment 6 of the present invention configured as mentioned above will be explained. The operation of this navigation device is the same as that of the navigation device in accordance with Embodiment 1 except for a last shot determining process (refer to FIG. 5). Hereafter, the details of the last shot determining process will be explained with reference to a flow chart shown in FIG. 16. The same reference characters as those used in Embodiment 1 are attached to the same steps as those of the last shot determining process carried out by the navigation device in accordance with Embodiment 1, and the explanation of the steps will be simplified hereafter.

In the last shot determining process, the last shot mode is turned off first (step ST31). A guidance object is then acquired (step ST32). The position of the guidance object is then acquired (step ST33). The vehicle position is then acquired (step ST34). Whether or not the distance between the guidance object and the vehicle is equal to or shorter than a fixed distance is then checked to see (step ST35). In contrast, when it is determined in step ST35 that the distance between the guidance object and the vehicle is not equal to or shorter than the fixed distance, the last shot mode is turned off (step ST37). After that, the sequence returns to step ST32 and the above-mentioned process is repeated.

In contrast, when it is determined in step ST35 that the distance between the guidance object and the vehicle is equal to or shorter than the fixed distance, whether or not the guidance object exists in a fixed area within the video image is then checked to see (step ST121). More specifically, the last shot determining unit 6a commands the guidance object detecting unit 14 to detect whether or not the guidance object is included in the fixed area of the video image. In response to this command, the guidance object detecting unit 14 performs a guidance object detecting process.

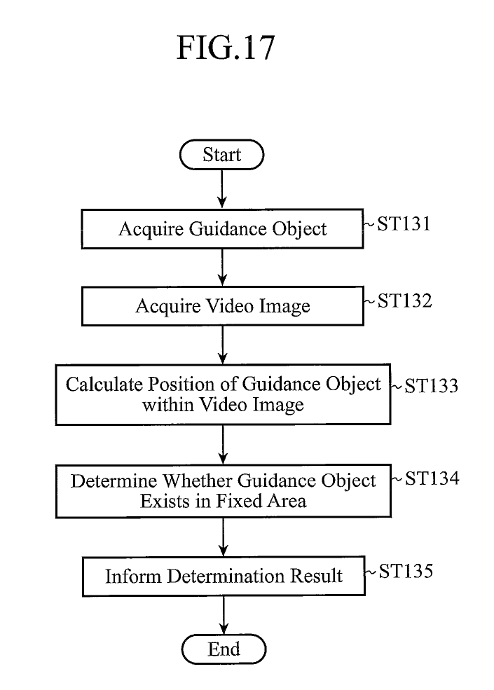

FIG. 17 is a flow chart showing the guidance object detecting process performed by the guidance object detecting unit 14. In this guidance object detecting process, the guidance object is acquired first (step ST131). More specifically, the guidance object detecting unit 14 acquires data about the guidance object (e.g. an intersection) from the route determining unit 22 of the navigation control unit 12. The video image is then acquired (step ST132). More specifically, the guidance object detecting unit 14 acquires the video data from the video image storage unit 11.

The position of the guidance object within the video image is then calculated (step ST133). More specifically, the guidance object detecting unit 14 calculates the position of the guidance object acquired in step ST131 within the video image acquired in step ST132. Concretely, the guidance object detecting unit 14 performs, for example, edge extraction on the video image shown by the video data acquired from the video image storage unit 11, compares this extracted edge with map data about an area surrounding the vehicle read from the map database 5 to carry out image recognition, and calculates the position of the guidance object within the video image. The image recognition can be alternatively carried out by using a method different from the above-mentioned one.

Whether or not the guidance object exists within the fixed area is then determined (step ST134). More specifically, the guidance object detecting unit 14 determines whether or not the position of the guidance object within the video image, which is calculated in step ST133, is located in the predetermined area. This predetermined area can be set up beforehand by the maker or a user of the navigation device. The result of the determination is then informed (step ST135). More specifically, the guidance object detecting unit 14 sends the result of the determination in step ST134 to the last shot determining unit 6a. After that, the guidance object detecting process is ended.

The guidance object detecting part 14 is configured in such a way as to calculate the position of the guidance object within the video image by carrying out the image recognition in the above-mentioned guidance object detecting process. The guidance object detecting unit 14 can be alternatively configured in such a way as to calculate the position of the guidance object by carrying out coordinate conversion based on transparent transformation using the vehicle position and heading data acquired from the position and heading measuring unit 4 and the map data about the area surrounding the vehicle acquired from the map database 5 without having to carry out any image recognition. As an alternative, the guidance object detecting unit can be configured in such a way as to calculate the position of the guidance object by using a combination of the method of carrying out the image recognition and the method of carrying out the coordinate conversion called transparent transformation.

The last shot determining unit 6a which has received the determination result from the guidance object detecting unit 14 determines whether or not to switch to the last shot mode on the basis of the route guidance data sent thereto from the route determining unit 22, the vehicle position and heading data sent thereto from the position and heading measuring unit 4, the map data acquired from the map database 5 and the result of the determination of whether or not the guidance object exists in the video image, which is sent thereto from the guidance object detecting unit 14.

When it is determined in above-mentioned step ST121 that the guidance object exists in the fixed area within the video image, the last shot mode is turned on (step ST36). After that, the sequence returns to step ST32 and the above-mentioned process is repeated. In contrast, when it is determined in step ST121 that the guidance object does not exist in the fixed area within the video image, the last shot mode is turned off (step ST37). After that, the sequence returns to step ST32 and the above-mentioned process is repeated.

The car navigation device is configured in such a way as to turn off the last shot mode when the distance between the guidance object and the vehicle is not equal to or shorter than the fixed distance in the above-mentioned last shot determining process. The car navigation device can be alternatively configured in such a way as to turn off the last shot mode when the guidance object goes into a region having 180 degrees behind the vehicle, when a fixed time interval predetermined by the maker or a user of the navigation device has elapsed, or when the guidance object goes into the region having 180 degrees and the fixed time interval has elapsed.

As explained above, the navigation device in accordance with Embodiment 6 of the present invention can present, as the last shot video image, only a video image in which a guidance object is included to a user.

The navigation device in accordance with above-mentioned Embodiment 6 is configured in such a way as to include the guidance object detecting unit 14 in addition to the components of the navigation device in accordance with Embodiment 1, and uses, as the last shot video image, a video image in which a guidance object is included, though the navigation device in accordance with above-mentioned Embodiment 6 can alternatively include the guidance object detecting unit 14 in addition to the components of the navigation device in accordance with any one of Embodiments 2 to 5 to implement the functions applied to the navigation device in accordance with Embodiment 6.

### Embodiment 7

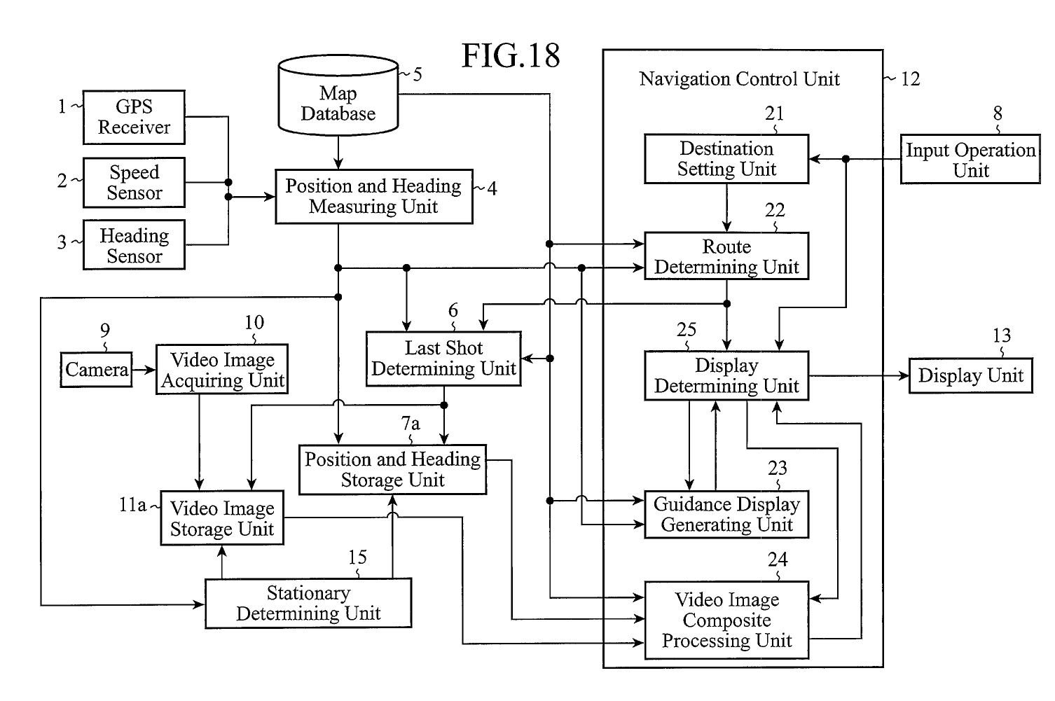

FIG. 18 is a block diagram showing the configuration of a navigation device in accordance with Embodiment 7 of the present invention. This navigation device is configured in such a way that a stationary determining unit 15 is added to the navigation control unit 12 of the navigation device in accordance with Embodiment 1, the position and heading storage unit 7 is replaced by a position and heading storage unit 7a, and the video image storage unit 11 is replaced by a video image storage unit 11a.

The stationary determining unit 15 acquires vehicle speed data from a speed sensor 2 via a position and heading measuring unit 4 to determine whether or not the vehicle is stationary. Concretely, when, for example, the speed data shows that the speed is equal or lower than a predetermined speed, the stationary determining unit 15 determines that the vehicle is stationary. The result of the determination by this stationary determining unit 15 is sent to the position and heading storage unit 7a and the video image storage unit 11a. The predetermined speed can be set to an arbitrary value by the maker or a user of the navigation device. The stationary determining unit can be alternatively configured in such a way as to determine that the vehicle is stationary when the state in which the vehicle speed is equal or lower than the predetermined speed continues for a fixed time period.

Next, the operation of the navigation device in accordance with Embodiment 7 of the present invention configured as mentioned above will be explained. The operation of this navigation device is the same as that of the navigation device in accordance with Embodiment 1 except for a video image storage process (refer to FIG. 6) and a vehicle position heading storage process (refer to FIG. 8). Hereafter, only a portion different from the operation of Embodiment 1 will be explained.

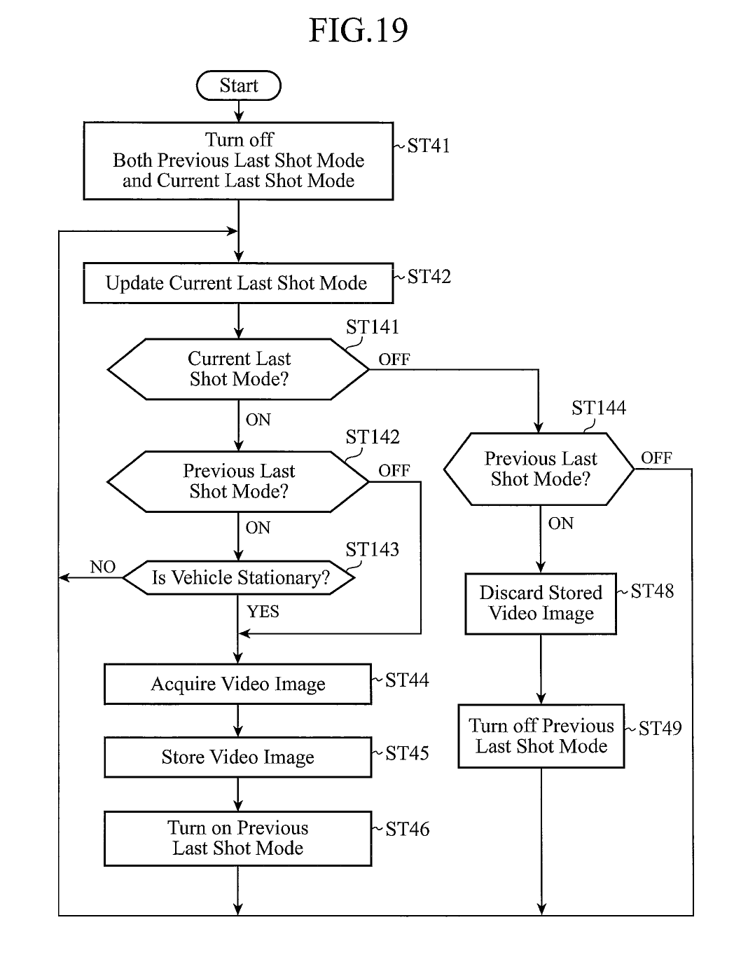

First, the details of the video image storage process will be explained with reference to a flow chart shown in FIG. 19. This video image storage process is mainly performed by the video image storage unit 11a and the stationary determining unit 15. The same reference characters as those used in Embodiment 1 are attached to the same steps as those of the last shot determining process carried out by the navigation device in accordance with Embodiment 1, and the explanation of the steps will be simplified hereafter. Hereafter, the video image storage unit 11 has an internal state which can be an on one or an off one for each of a previous last shot mode and a current last shot mode.

In the video image storage process, both the current last shot mode and the previous last shot mode are turned off first (step ST41). The current last shot mode is then updated (step ST42). The current last shot mode is then checked to see (step ST141). More specifically, the video image storage unit 11a checks to see the current last shot mode which the video image storage unit holds therein.

When it is determined in this step ST141 that the current last shot mode is in the on state, the previous last shot mode is then checked to see (step ST142). More specifically, the video image storage unit 11a checks to see the previous last shot mode which the video image storage unit holds therein. When it is determined in this step ST142 that the previous last shot mode is in the off state, the sequence advances to step ST144. In contrast, when it is determined in step ST142 that the previous last shot mode is in the on state, whether or not the vehicle is stationary is then checked to see (step ST143). More specifically, the video image storage unit 11a checks to see whether or not a signal showing that the vehicle is stationary has been sent from the stop determining unit 15.

When it is determined in this step ST143 that the vehicle is not stationary, the sequence returns to step ST42 and the above-mentioned process is repeated. In contrast, when it is determined in step ST143 that the vehicle is stationary, the sequence advances to step ST44. A video image is acquired in step ST44. The video image is then stored (step ST45). The previous last shot mode is then turned on (step ST46). After that, the sequence returns to step ST42 and the above-mentioned process is repeated.

When it is determined in above-mentioned step ST141 that the current last shot mode is in the off state, the previous last shot mode is then checked to see (step ST144). More specifically, the video image storage unit 11a checks to see the previous last shot mode which the video image storage unit holds therein. When it is determined in this step ST144 that the previous last shot mode is in the off state, the sequence returns to step ST42 and the above-mentioned process is repeated. In contrast, when it is determined in step ST144 that the previous last shot mode is in the on state, the video image stored is then discarded (step ST48). The previous last shot mode is then turned off (step ST49). More specifically, the last shot mode is released. After that, the sequence returns to step ST42 and the above-mentioned process is repeated.

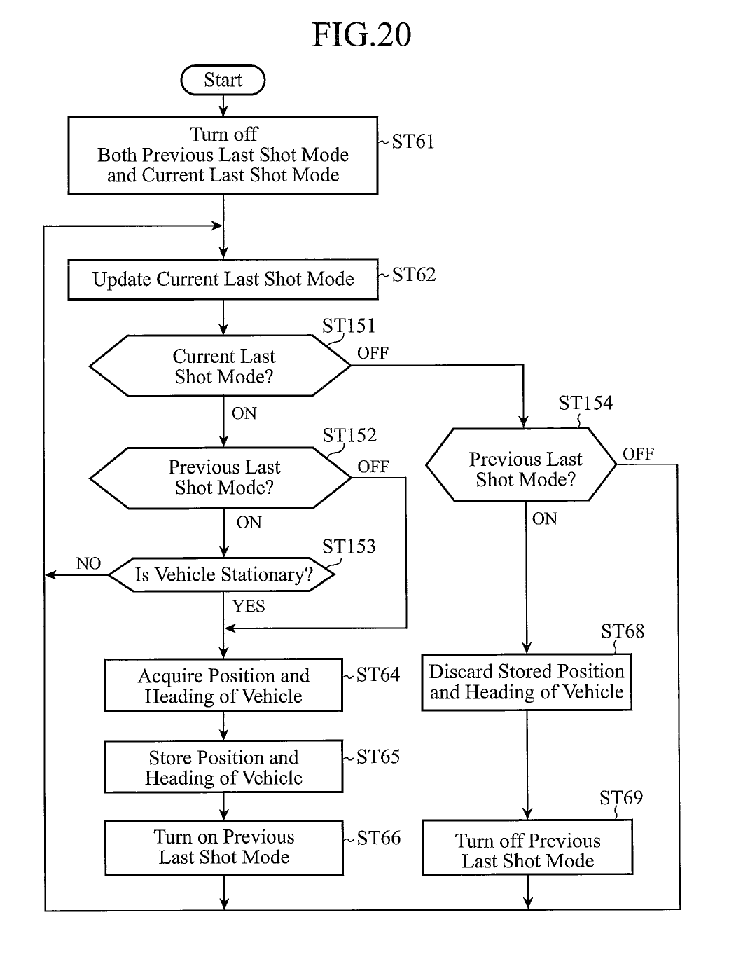

Next, the details of the vehicle position and heading storage process will be explained with reference to a flow chart shown in FIG. 20. This vehicle position and heading storage process is mainly performed by the position and heading storage unit 7a and the stationary determining unit 15. The same reference characters as those used in Embodiment 1 are attached to the same steps as those of the last shot determining process carried out by the navigation device in accordance with Embodiment 1, and the explanation of the steps will be simplified hereafter. Hereafter, the video image storage unit 11 has an internal state which can be an on one or an off one for each of the previous last shot mode and the current last shot mode.

In the vehicle position and heading storage process, both the current last shot mode and the previous last shot mode are turned off first (step ST61). The current last shot mode is then updated (step ST62). The current last shot mode is then checked to see (step ST151). More specifically, the position and heading storage unit 7a checks to see the current last shot mode which the position and heading storage unit holds therein.

When it is determined in this step ST151 that the current last shot mode is in the on state, the previous last shot mode is then checked to see (step ST152). More specifically, the position and heading storage unit 7a checks to see the previous last shot mode which the position and heading storage unit holds therein. When it is determined in this step ST152 that the previous last shot mode is in the off state, the sequence advances to step ST64. In contrast, when it is determined in step ST152 that the previous last shot mode is in the on state, whether or not the vehicle is stationary is then checked to see (step ST153). More specifically, the position and heading storage unit 7a checks to see whether or not the signal showing that the vehicle is stationary has been sent from the stop determining unit 15.

When it is determined in this step ST153 that the vehicle is not stationary, the sequence returns to step ST42 and the above-mentioned process is repeated. In contrast, when it is determined in step ST153 that the vehicle is stationary, the sequence advances to step ST64. The position and heading of the vehicle are acquired in step ST64 . The position and heading of the vehicle are then stored (step ST65). The previous last shot mode is then turned on (step ST66). After that, the sequence returns to step ST62 and the above-mentioned process is repeated.

When it is determined in above-mentioned step ST151 that the current last shot mode is in the off state, the previous last shot mode is then checked to see (step ST154). More specifically, the position and heading storage unit 7a checks to see the previous last shot mode which the position and heading storage unit holds therein. When it is determined in this step ST154 that the previous last shot mode is in the off state, the sequence returns to step ST62 and the above-mentioned process is repeated. In contrast, when it is determined in step ST154 that the previous last shot mode is in the on state, the vehicle heading of the vehicle stored is then discarded (step ST68). The previous last shot mode is then turned off (step ST69). More specifically, the last shot mode is released. After that, the sequence returns to step ST62 and the above-mentioned process is repeated.

As previously explained, the navigation device in accordance with Embodiment 7 of the present invention can stop the guidance using the last shot video image when the vehicle stops after presenting the last shot video image, and, after that, when vehicles starts traveling, can return to the guidance using the last shot video image. Therefore, the navigation device in accordance with Embodiment 7 of the present invention can change the guidance according to how much time the driver pays to anything else than driving. More specifically, because it can be determined that the driver pays much time to anything else than driving when the vehicle is stationary, the navigation device can capture a video image again and provide guidance using the current video image.

The navigation device in accordance with above-mentioned Embodiment 7 is configured in such a way as to include the stop determining unit 15 in addition to the components of the navigation device in accordance with Embodiment 1, and, when this stop determining unit 15 determines that the vehicle is stationary, stops the guidance using the last shot video image, though the navigation device in accordance with above-mentioned Embodiment 7 can be alternatively configured in such a way as to include the stop determining unit 15 in addition to the components of the navigation device in accordance with any one of Embodiments 2 to 6, and implement the same functions as those of the navigation device in accordance with Embodiment 7.

In above-mentioned Embodiments 1 to 7, as an example of the navigation device in accordance with the present invention, a car navigation device applied to vehicles is taken and is explained. However, the navigation device in accordance with the present invention can be applied not only to a car navigation device, but also to moving objects such as a mobile phone equipped with a camera and an airplane.

### INDUSTRIAL APPLICABILITY

As mentioned above, the navigation device in accordance with the present invention excels in presenting appropriate information to users when the vehicle is in the neighborhood of a guidance object, and is therefore widely applicable to a navigation device intended for moving objects, such as a car navigation device, a mobile phone equipped with a camera, and an airplane.

1. A navigation device comprising:
a map database holding map data;
a position and heading measuring unit for measuring a current position;
a video image acquiring unit for acquiring a video image;
a last shot determining unit for, when a distance from the current position acquired by said position and heading measuring unit to a guidance object is equal to or shorter than a fixed distance and a distance from a current position calculated on a basis of map data acquired from the map database to the guidance object is equal to or shorter than the fixed distance, determining to switch to a last shot mode in which a video image acquired by said video image acquiring unit at that time is fixedly and continuously outputted;
a video image storage unit for storing, as a last shot video image, a video image acquired by said video image acquiring unit at a time when said last shot determining unit determines to switch to the last shot mode;
a video image composite processing unit for reading the last shot video image stored in said video image storage unit, and for superimposing a content including a graphic, a character string or an image for explaining the guidance object existing in said last shot video image on said read last shot video image to generate a composite video image; and
a display unit for displaying the composite video image generated by said video image composite processing unit.

2. The navigation device according to claim 1, wherein said navigation device has a camera for capturing a video image of a frontal area, and said video image acquiring unit acquires the video image of the frontal area captured by said camera as a three-dimensional video image.

3. The navigation device according to claim 2, wherein the last shot determining unit changes the fixed distance according to a size of the guidance object.

4. The navigation device according to claim 2, wherein the last shot determining unit changes the fixed distance according to conditions of a road.

5. The navigation device according to claim 2, wherein the last shot determining unit changes the fixed distance according to a traveling speed of the navigation device itself.

6. The navigation device according to claim 2, wherein the last shot determining unit changes the fixed distance according to surrounding conditions.

7. The navigation device according to claim 1, wherein said navigation device includes a guidance object detecting unit for detecting whether or not a guidance object is included in the last shot video image acquired from the video image storage unit, and, when the distance from the current position acquired by said position and heading measuring unit to the guidance object is equal to or shorter than the fixed distance and the distance from the current position calculated on the basis of the map data acquired from the map database to the guidance object is equal to or shorter than the fixed distance, and said guidance object detecting unit detects that the guidance object is included in the last shot video image, the last shot determining unit determines to switch to the last shot mode.

8. The navigation device according to claim 1, wherein said navigation device includes a stationary determining unit for determining whether or not the navigation device is stationary, and the last shot determining unit determines to release the last shot mode when said stationary determining unit determines that the navigation device is stationary, the video image storage unit sends out a video image newly acquired by said video image acquiring unit just as it is when said last shot determining unit determines to release the last shot mode, and the video image composite processing unit superimposes a content for explaining a guidance object existing in said video image sent thereto from said video image storage unit on said video image to generate a composite video image.
